(19) United States
(12) Patent Application Publication
(10) Pub. No.: US 2025/0300755 A1
(43) Pub. Date: Sep. 25, 2025

(54) DOWNSTREAM STATE AWARE LOADING MANAGEMENT IN AN ORCHESTRATED OPTICAL NETWORK

(71) Applicant: Infinera Corp., San Jose, CA (US)

(72) Inventors: Nikhil K. Satyarthi, Yelahanka (IN); Aryabhata Deshpande, Bommanahalli (IN); Barahidhar Ramanathan, Karnataka (IN)

(21) Appl. No.: 19/090,073

(22) Filed: Mar. 25, 2025

Related U.S. Application Data
(60) Provisional application No. 63/569,706, filed on Mar. 25, 2024.

(51) Int. Cl. H04J 14/02; G02B 6/35

(52) U.S. Cl. CPC H04J 14/0212; G02B 6/3586; G02B 6/3594; H04J 14/0232; H04J 14/0261

(57) ABSTRACT

Methods and systems include a method, comprising: providing, by an orchestrator of a network element, an optical service loading request identifying requested passbands to be loaded on a wavelength selective switch (WSS) for transmission of optical content; determining, by a loading manager of the network element, a subset of the requested passbands to be loaded on the WSS based on a downstream band signal status; and loading, by control blocks of the network element, the subset of the requested passbands on the WSS. The optical content includes client data and amplified spontaneous emission (ASE) noise. The network element comprises an ASE source, a light source, a light sink, a line port coupled to an optical fiber link, tributary ports, and the WSS. At least one of the tributary ports is coupled to the ASE source. The light source and the light sink transmit and receive the client data, respectively.

### CROSS-REFERENCE TO RELATED APPLICATIONS

This application claims priority to the provisional patent applications identified by U.S. Patent Application No. 63/569,706, filed Mar. 25, 2024, the entire content of which is hereby expressly incorporated herein by reference.

### BACKGROUND ART

Optical networking is a communication means that utilizes signals encoded in light to transmit information, e.g., data, as an optical signal in various types of telecommunications networks. Optical networking may be used in relatively short-range networking applications such as in a local area network (LAN) or in long-range networking applications spanning countries, continents, and oceans. Generally, optical networks utilize optical amplifiers, a light source such as lasers or LEDs, and wavelength division multiplexing to enable high-bandwidth communication.

Optical networks are a critical component of the global Internet backbone. This infrastructure acts as the underlay, providing the plumbing for all other communications to take place (e.g., access, metro, and long-haul). In the traditional 7-layer OSI model, Optical networks constitute the Layer 1 functions, providing digital transmission of bit streams transparently across varying distances over a chosen physical media (in this case, optical). Optical networks also encompass an entire class of devices (which are referred to as Layer 0), which purely deal with optical photonic transmission and wavelength division multiplexing (WDM). This includes amplification, (re-)generation, and optical add/drop multiplexing (OADM). The most widely adopted Layer 1/Layer 0 transport networking technologies today, referred to as Optical Transport Networks (OTN), are based on ITU-T standards. Both these classes of networks are connection-oriented and circuit-switched in nature.

Dense Wavelength Division Multiplexing (DWDM) is an optical transmission technology that uses a single optical fiber link to simultaneously transport multiple optical services of different wavelengths. The different wavelengths are conventionally separated into several frequency bands, each frequency band being used as an independent channel to transport optical services of particular wavelengths. The Conventional Band (C-band) typically includes signals with wavelengths ranging from 1530 nm to 1565 nm, is the frequency band in which optical services experience the lowest amount of loss, and is the band most commonly used in DWDM. The Long-wavelength Band (L-band), which typically includes signals with wavelengths ranging from 1565 nm to 1625 nm, is the frequency band in which optical services experience the second lowest amount of loss, and is the frequency band often used when the C-band is insufficient to meet bandwidth requirements. Optical line systems that use both the C-band and the L-band are referred to as C+L or C/L optical line systems.

C+L optical line systems may be susceptible to experiencing significant optical power transients during loading operations due to the Stimulated Raman Scattering (SRS) effect across different frequency bands. This can lead to traffic drops on pre-existing services in one frequency band if there is a significant loading change in another frequency band.

Generally, in C+L optical line systems, to mitigate power transients due to loading changes in the transmission line caused by activation or deactivation of services, amplified spontaneous emission (ASE) noise is filled in the spectral gaps where the signal is absent to keep power levels maintained at a constant level in the transmission line. When a new service is activated, the ASE noise in the associated part of the spectrum is replaced with the signal associated with the new service. When an old service is deactivated, the signal in the associated part of the spectrum is replaced with ASE noise. Through this mechanism, the power levels in the transmission line are maintained around a constant level irrespective of the number of services activated or deactivated in the spectrum. Similar to C+L optical line systems, the mechanism to keep the spectrum fully occupied with either signal or ASE noise is used in sub-marine line terminating equipment (SLTE) networks as well. SLTE systems require the transmission line to have constant power at all times since the amplifiers used under the sea operate in constant power mode. For this reason, the spectrum needs to be completely filled with either user services or ASE noise at all times so that the amplifier input power remains constant at all times. The current disclosure can be used exactly in the same form for SLTE networks as well and is not limited to C+L optical networks alone. Similarly, the current disclosure can be used exactly in the same form for Super-C/Super-L/Super-C+L networks as well and is not restricted to standard-C band or standard-L band networks alone.

In C+L optical line systems, careful loading of services is desired to minimize the amount and associated effects of optical power changes on pre-existing services across other bands due to the Stimulated Raman Scattering (SRS) phenomena. Unlike C-band only networks, where loading services in part of the spectrum can be done independently to a certain extent without considering pre-existing services in another part of the spectrum, C+L optical line systems utilize orchestration over automatic Wavelength Selective Switch (WSS) controls and Link controls.

In C+L optical line systems, parts of a spectrum of a band are loaded in smaller chunks followed by correction of power changes on pre-existing services which may have occurred due to the SRS effect across bands. Once a chunk of spectrum is loaded on the outgoing transmission line of a Reconfigurable Optical Add-Drop Multiplexer (ROADM), power correction requests are issued to the WSS controls and line amplifier controls before any further chunk of spectrum is loaded. These power corrections are desired on the outgoing transmission line of the local ROADM where the chunk of spectrum is loaded and the immediate downstream ROADM which may carry optically dependent pre-existing services. This loading management and the power corrections utilize orchestration that manages the WSS controls and Link controls on the local ROADM and the immediate downstream ROADM.

The Service and Power Control Orchestrator (SPCO) achieves this orchestration function required in C+L optical line systems, working as an overlay over the automatic control loops controlling the optical devices. It must be noted that SPCO and the orchestration function may also be used in a single-band network to minimize impacts due to SRS, which may not be as pronounced as in a multi-band network where it can be traffic impacting. The same SPCO and the orchestration function may also be used in the SLTE deployments where the amount of power changes introduced on the transmission line needs to be controlled by carrying out the loading in the spectrum in multiple chunks and cycles so that the input power to the constant power mode amplifier does not change significantly. In an orchestration-driven network, complete loading for a certain number of services on a ROADM may involve multiple loading cycles with each cycle involving: (i) loading a certain part of the spectrum to ensure minimal SRS impact on pre-existing services; (ii) adjusting power levels on the local ROADM and gain elements in the link to compensate against power changes; and (iii) adjusting power levels on the remote ROADM to compensate against power changes.

The loading within the control block and subsequent correction in power levels for pre-existing services can be quite time-consuming as it may involve multiple operations to be executed in the underlying control blocks on local and remote ROADMs. Multiple such loading cycles would delay the overall link turn-up/turn-down time involving all these services. Hence, it is desirable to reduce the number of these loading cycles to reduce the overall link turn-up/turn-down time, which would provide a better user experience.

In implementations available in the prior art, the loading decision on a multiplexer (MUX) of a local ROADM accounts for local MUX passband activation status for estimating the worst-case SRS impacts and hence generates appropriate loading responses spread across one or multiple loading cycles. It is assumed that the MUX passband which is activated locally is also activated on the immediately downstream ROADM for estimating the worst-case SRS impacts in the network to make the loading decisions.

In the implementations available in the prior art, in certain use-cases conservative loading decisions are made leading to multiple loading cycles which delays the overall link turn-up/turn-down time. The loading management on the MUX of the local ROADM has no visibility of the activation status of the signal services on the downstream ROADM. It is not possible in such implementations to optimize the loading decision or the number of loading cycles when the signal services are active on the local ROADM but not active on the downstream ROADM.

When the signal services in a band are not active on the downstream ROADM, the loading decisions on the local MUX can be more aggressive requiring fewer loading cycles since the SRS impact due to loading, even if present on the local optical span, would not cause any impact on the traffic carried in the network since such signal services are not opened in the de-multiplexer (DEMUX) of the downstream ROADM. The traffic carried on these signal services is not received by any of the drop transponders connected to the line system. These signal services have no optical dependency with other signal services in the downstream optical network.

In such use cases, a reduced number of loading cycles is desired to reduce the overall link turn-up/turn-down time, which would provide a better user experience.

### SUMMARY OF THE INVENTION

The problem of reducing the number of loading cycles in which optical services are loaded without increasing the effects of SRS on the optical services is addressed by the systems and methods described herein. As described herein, loading management on a local ROADM may account for a band signal status of an immediate downstream ROADM in order to reduce the effects of SRS on the optical services while also reducing the number of loading cycles in which the optical services are loaded. If a C-band signal status or an L-band signal status are DOWN (i.e., deactivated) on the immediate downstream ROADM, the loading management decisions on the local ROADM may be permitted to be more aggressive in certain use cases described herein.

In one embodiment, the present disclosure includes a network element, comprising: a processor; an amplified spontaneous emission (ASE) source operable to generate ASE noise; a line port configured to be optically coupled to an optical fiber link; one or more tributary ports, at least one of the one or more tributary ports configured to be optically coupled to the ASE source; a wavelength selective switch (WSS) in optical communication with the line port and the one or more tributary ports, the WSS being configured to selectively route optical content between the one or more tributary ports and the line port to selectively activate and deactivate a plurality of passbands for transmission of the optical content via the line port over the optical fiber link, the optical content having been received via at least one of the one or more tributary ports and including one or more of client data and the ASE noise; a memory comprising a non-transitory processor-readable medium storing an orchestrator application, a loading manager application, one or more control block applications, and processor-executable instructions that when executed by the processor cause the processor to: provide, by the orchestrator application, an optical service loading request identifying one or more requested passbands of the plurality of passbands to be one of activated and deactivated on the WSS for transmission of the optical content; determine, by the loading manager application, a subset of the one or more requested passbands to be one of activated and deactivated on the WSS across one or more loading cycles for transmission of the optical content based at least in part on a downstream band signal status indicating whether any of the plurality of passbands in one or more predetermined frequency ranges are activated on a downstream WSS of a downstream network element for transmission of the client data; and activate or deactivate, by at least one of the one or more control block applications, the subset of the one or more requested passbands on the WSS across the one or more loading cycles for transmission of the optical content.

In another embodiment, the present disclosure includes a method, comprising: providing, by an orchestrator application of a network element, an optical service loading request, the network element comprising an amplified spontaneous emission (ASE) source operable to generate ASE noise, a line port optically coupled to an optical fiber link, one or more tributary ports wherein at least one of the one or more tributary ports is optically coupled to the ASE source, and a wavelength selective switch (WSS) in optical communication with the line port and the one or more tributary ports, the WSS being configured to selectively route optical content between the one or more tributary ports and the line port to selectively activate and deactivate a plurality of passbands for transmission of the optical content via the line port over the optical fiber link, the optical content having been received via at least one of the one or more tributary ports and including one or more of client data and the ASE noise, the optical service loading request identifying one or more requested passbands of the plurality of passbands to be one of activated and deactivated on the WSS for transmission of the optical content; determining, by a loading manager application of the network element, a subset of the one or more requested passbands to be one of activated and deactivated on the WSS across one or more loading cycles for transmission of the optical content based at least in part on a downstream band signal status indicating whether any of the plurality of passbands in one or more predetermined frequency ranges are activated on a downstream WSS of a downstream network element for transmission of the client data; and activating or deactivating, by at least one of one or more control block applications of the network element, the subset of the one or more requested passbands on the WSS across the one or more loading cycles for transmission of the optical content.

### BRIEF DESCRIPTION OF THE DRAWINGS

The accompanying drawings, which are incorporated in and constitute a part of this specification, illustrate one or more embodiments described herein and, together with the description, explain these embodiments. The drawings are not intended to be drawn to scale, and certain features and certain views of the figures may be shown exaggerated, to scale or in schematic in the interest of clarity and conciseness. Not every component may be labeled in every drawing. Like reference numerals in the figures may represent and refer to the same or similar element or function. In the drawings:

FIG. 1 is a block diagram of an exemplary embodiment of an optical transport network constructed in accordance with the present disclosure.

FIG. 2 is a diagram of an exemplary embodiment of a computer system shown in FIG. 1 and constructed in accordance with the present disclosure.

FIG. 3A is a block diagram of an exemplary embodiment of the network element being a reconfigurable optical add/drop multiplexer constructed in accordance with the present disclosure.

FIG. 3B is a diagram of an exemplary embodiment of a light source of FIG. 3A constructed in accordance with the present disclosure.

FIG. 3C is a block diagram of an exemplary embodiment of a light sink constructed in accordance with the present disclosure.

FIG. 3D is a diagram of an exemplary embodiment of a flexible ROADM module (FRM) constructed in accordance with the present disclosure.

FIG. 4 is a software architecture diagram of an exemplary embodiment of a Service and Power Control Orchestrator constructed in accordance with the present disclosure.

FIG. 5 is a diagram of an exemplary embodiment of an adjacency graph of the third network element of FIG. 1 constructed in accordance with the present disclosure.

FIG. 6A is a functional diagram of an exemplary embodiment of a logical ROADM model constructed in accordance with the present disclosure.

FIG. 6B is a block diagram of another exemplary embodiment of a physical topology of a ROADM constructed in accordance with the present disclosure.

FIG. 7 is a functional diagram of an exemplary embodiment of an optical services and power controls subsystem constructed in accordance with the present disclosure.

FIG. 8 is a block diagram of an exemplary embodiment of an orchestrator implemented on a ROADM with multiple degrees and constructed in accordance with the present disclosure.

FIG. 9 is a block diagram of an exemplary embodiment of an orchestrator network constructed in accordance with the present disclosure.

FIG. 10 is a block diagram of an exemplary embodiment of an optical transport network segment constructed in accordance with the present disclosure.

FIG. 11 is a block diagram of an exemplary embodiment of a multiplexer (MUX) wavelength selective switch (WSS) constructed in accordance with the present disclosure.

FIG. 12A is a block diagram of an exemplary embodiment of a demultiplexer (DEMUX) WSS constructed in accordance with the present disclosure.

FIG. 12B is a block diagram of another exemplary embodiment of the DEMUX WSS shown in FIG. 12A.

FIG. 12C is a block diagram of another exemplary embodiment of the DEMUX WSS shown in FIGS. 12A-12B.

FIG. 12D is a block diagram of another exemplary embodiment of the DEMUX WSS shown in FIGS. 12A-12C.

FIG. 13 is a process flow diagram of an exemplary embodiment of a method of loading (i.e., activating or deactivating) passbands in accordance with the present disclosure.

FIG. 14 is a cross-functional process flow diagram of another exemplary embodiment of a method of loading (i.e., activating or deactivating) passbands in accordance with the present disclosure.

### DETAILED DESCRIPTION

The following detailed description of exemplary embodiments refers to the accompanying drawings. The same reference numbers in different drawings may identify the same or similar elements.

Before explaining at least one embodiment of the disclosure in detail, it is to be understood that the disclosure is not limited in its application to the details of construction, experiments, exemplary data, and/or the arrangement of the components set forth in the following description or illustrated in the drawings unless otherwise noted.

The disclosure is capable of other embodiments or of being practiced or carried out in various ways. Also, it is to be understood that the phraseology and terminology employed herein are for purposes of description and should not be regarded as limiting.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concept. This description should be read to include one or more and the singular also includes the plural unless it is obvious that it is meant otherwise. Further, use of the term “plurality” is meant to convey “more than one” unless expressly stated to the contrary.

As used herein, qualifiers like “about,” “approximately,” and combinations and variations thereof, are intended to include not only the exact amount or value that they qualify, but also some slight deviations therefrom, which may be due to manufacturing tolerances, measurement error, wear and tear, stresses exerted on various parts, and combinations thereof, for example.

The use of the term “at least one” or “one or more” will be understood to include one as well as any quantity more than one. In addition, the use of the phrase “at least one of X, Y, and Z” will be understood to include X alone, Y alone, and Z alone, as well as any combination of X, Y, and Z.

The use of ordinal number terminology (i.e., “first”, “second”, “third”, “fourth”, etc.) is solely for the purpose of differentiating between two or more items and, unless explicitly stated otherwise, is not meant to imply any sequence or order or importance to one item over another or any order of addition.

As used herein, any reference to “one embodiment,” “an embodiment,” “some embodiments,” “one embodiment,” “some embodiments,” “an embodiment,” “one example,” “for example,” or “an example” means that a particular element, feature, structure, or characteristic described in connection with the embodiment/embodiment/example is included in at least one embodiment/embodiment/example and may be used in conjunction with other embodiments/embodiments/examples. The appearance of the phrase “in some embodiments” or “one example” or “in some embodiments” in various places in the specification does not necessarily all refer to the same embodiment/embodiment/example, for example.

Circuitry, as used herein, may be analog and/or digital components referred to herein as “blocks”, or one or more suitably programmed processors (e.g., microprocessors) and associated hardware and software, or hardwired logic. Also, “components” or “blocks” may perform one or more functions. The term “component” or “block” may include hardware, such as a processor (e.g., a microprocessor), a combination of hardware and software, and/or the like. Software may include one or more processor-executable instructions that when executed by one or more components cause the component to perform a specified function. It should be understood that the algorithms described herein may be stored on one or more non-transitory memory. Exemplary non-transitory memory may include random access memory, read-only memory, flash memory, and/or the like. Such non-transitory memory may be electrically based, optically based, and/or the like.

Software may include one or more processor-readable instruction that when executed by one or more component, e.g., a processor, causes the component to perform a specified function. It should be understood that the algorithms described herein may be stored on one or more non-transitory processor-readable medium, which is also referred to herein as a non-transitory memory. Exemplary non-transitory processor-readable mediums may include random-access memory (RAM), a read-only memory (ROM), a flash memory, and/or a non-volatile memory such as, for example, a CD-ROM, a hard drive, a solid-state drive, a flash drive, a memory card, a DVD-ROM, a Blu-ray Disk, a disk, and an optical drive, combinations thereof, and/or the like. Such non-transitory processor-readable media may be electrically based, optically based, magnetically based, and/or the like. Further, the messages described herein may be generated by the components and result in various physical transformations.

As used herein, the terms “network-based,” “cloud-based,” and any variations thereof, are intended to include the provision of configurable computational resources on demand via interfacing with a computer and/or computer network, with software and/or data at least partially located on a computer and/or computer network.

The generation of laser beams for use as optical data channel signals is explained, for example, in U.S. Pat. No. 8,155,531 B2, titled “Tunable Photonic Integrated Circuits”, issued Apr. 10, 2012, and U.S. Pat. No. 8,639,118 B2, titled “Wavelength division multiplexed optical communication system having variable channel spacings and different modulation formats,” issued Jan. 28, 2014, which are hereby fully incorporated in their entirety herein by reference.

As used herein, an “optical communication path” and/or an “optical route” may correspond to an optical path and/or an optical light path. For example, an optical communication path may specify a path along which light is carried between two or more network entities along a fiber optic link, e.g., an optical fiber.

The optical network has one or more band. A band is the complete optical spectrum carried on the optical fiber. Depending on the optical fiber used and the supported spectrum which can be carried over long distances with the current technology, relevant examples of the same are: C-Band/L-Band/Extended-C-Band/Super-C-Band/Super-L-Band. As used herein, the C-Band is a band of light having a wavelength between about 1530 nm and about 1565 nm. The L-Band is a band of light having a wavelength between about 1565 nm and about 1625 nm. Because the wavelength of the C-Band is smaller than the wavelength of the L-Band, the wavelength of the C-Band may be described as a short, or a shorter, wavelength relative to the L-Band. Similarly, because the wavelength of the L-Band is larger than the wavelength of the C-Band, the wavelength of the L-Band may be described as a long, or a longer, wavelength relative to the C-Band.

As used herein, a spectral slice (a “slice”) may represent a spectrum of a particular size in a frequency band (e.g., 12.5 gigahertz (“GHz”), 6.25 GHZ, 3.125 GHz, etc.). For example, a 4.8 terahertz (“THz”) frequency band may include 384 spectral slices, where each spectral slice may represent 12.5 GHz of the 4.8 THz spectrum. A slice may be the resolution at which the power levels can be measured by the optical power monitoring device. The power level being measured by the optical power monitoring device represents the total optical power carried by the portion of the band represented by that slice.

Spectral loading, or channel loading, is the addition of one or more channel to a specific spectrum of light described by the light's wavelength in an optical signal. When all channels within a specific spectrum are being utilized, the specific spectrum is described as fully loaded. A grouping of two or more channel may be called a channel group. Spectral loading may also be described as the addition of one or more channel group to a specific spectrum of light described by the light's wavelength to be supplied onto the optical fiber as the optical signal.

A WSS (Wavelength Selective Switch) is a component used in optical communications networks to route (switch) optical signals between optical fibers on a per-slice basis. Generally, power level controls can also be done by the WSS by specifying an attenuation level on a passband filter. A wavelength Selective Switch is a programmable device having source and destination fiber ports where the source and destination fiber ports and associated attenuation can be specified for a particular passband with a minimum bandwidth.

A reconfigurable optical add-drop multiplexer (ROADM) node is an all-optical subsystem that enables remote configuration of wavelengths at any ROADM node. A ROADM is software-provisionable so that a network operator can choose whether a wavelength is added, dropped, or passed through the ROADM node. The technologies used within the ROADM node include wavelength blocking, planar lightwave circuit (PLC), and wavelength selective switching-though the WSS has become the dominant technology. A ROADM system is a metro/regional WDM or long-haul DWDM system that includes a ROADM node. ROADMs are often talked about in terms of degrees of switching, ranging from a minimum of two degrees to as many as eight degrees, and occasionally more than eight degrees. A “degree” is another term for a switching direction and is generally associated with a transmission fiber pair. A two-degree ROADM node switches in two directions, typically called East and West. A four-degree ROADM node switches in four directions, typically called North, South, East, and West. In a WSS-based ROADM network, each degree requires an additional WSS switching element. So, as the directions switched at a ROADM node increase, the ROADM node's cost increases.

An exemplary optical transport network consists of two distinct domains: Layer 0 (“optical domain” or “optical layer”) and Layer 1 (“digital domain”) data planes. Layer 0 is responsible for fixed or reconfigurable optical add/drop multiplexing (R/OADM) and optical amplification (EDFA or Raman) of optical channels and optical channel groups (OCG), typically within the 1530 nm-1565 nm range, known as C-Band. ROADM functions are facilitated via usage of a combination of colorless, directionless, and contentionless (CDC) optical devices, which may include wavelength selective switches (WSS), Multicast switches (MCS). Layer 0 may include the frequency grid (for example, as defined by ITU G.694.1), ROADMs, FOADMs, Amps, Muxes, Line-system and Fiber transmission, and GMPLS Control Plane (with Optical Extensions). Layer 1 functions encompass transporting client signals (e.g., Ethernet, SONET/SDH) in a manner that preserves bit transparency, timing transparency, and delay-transparency. The predominant technology for digital layer data transport in use today is OTN (for example, as defined by ITU G.709). Layer 1 may transport “client layer” traffic. Layer 1 may be a digital layer including multiplexing and grooming. The optical layer may further be divided into either an OTS layer or an OCH layer. The OTS layer refers to the optical transport section of the optical layer, whereas the OCH layer refers to one or more optical channels which are co-routed, e.g., together as multiple channels.

As used herein, a “loading cycle” refers to a structured process of managing and activating optical passbands. This cycle begins with the presentation of passbands ready for loading, along with their eligible frequency markers, to a loading manager. The loading manager then selects a subset of these passbands, forming a batch to be loaded in a single operation. Following the loading of this batch, adjustments are made in both local and remote control blocks to optimize system performance. This cycle repeats iteratively, with the loading manager continually assessing the pending list of passbands and making loading decisions until no passbands remain pending. The loading cycle allows for dynamic allocation of resources, ensuring that passbands are activated or deactivated as needed while maintaining system stability. The criteria used by the loading manager to determine which passbands to load in each cycle can be based on various factors, such as worst-case SRS estimation, to minimize disruption to existing traffic. This systematic approach to passband management enables the optical line system to adapt to changing network conditions and requirements, ultimately enhancing overall performance and reliability.

An exemplary loading manager is described in U.S. Patent Publication No. 2023/0327762 A1, titled “Method of Transient Management in Optical Transmission Systems”, filed Apr. 7, 2023, and published Oct. 12, 2023, and U.S. Patent Publication No. 2023/0224039 A1, titled “User Configurable Spectral Loading in an Optical Line System, Using Policies and Parameters”, filed Dec. 27, 2022, the entire contents of each of which are hereby incorporated herein by reference in their entirety.

Exemplary means of making adjustments to local and remote control blocks are described in U.S. Patent Publication No. 2023/0327794 A1, titled “Systems and Methods for Correcting Downstream Power Excursions During Upstream Loading Operations in Optical Networks”, filed Apr. 7, 2023, and U.S. Patent Publication No. 2023/0224063 A1, titled, “Coordinator for Managing Optical Power Controls in a C+L Band Network”, filed Jan. 10, 2023, the entire contents of each of which are hereby incorporated herein by reference in their entirety.

The present invention provides significant advantages over prior art systems in optical network management. Conventional systems face challenges during a cold-boot or jack-out/jack-in (JOJI) event of a multiplexer (MUX) wavelength selective switch (WSS) module or when recovering from multiple network failures that occur within a short time interval. These situations typically result in staggered readiness of signal and amplified spontaneous emission (ASE) passbands for activation across extended time periods. This staggered readiness causes systems to miss pre-defined aggregation windows for service loading in the orchestrator and creates contention between newly-ready signal passbands and previously activated ASE passbands. In prior implementations, these scenarios trigger multiple conservative loading cycles that significantly slow the recovery process. The optimization techniques disclosed in this invention enable more aggressive loading decisions, substantially accelerating overall network recovery times.

Prior art systems also face challenges when loading services in single-band networks that interoperate with multi-band networks through transit ROADMs. The optimization described herein eliminates the need for special user configurations and loading policy definitions for ROADMs operating on a single band. In these configurations, the downstream band signal status for non-present bands remains in a DOWN (i.e., deactivated) state. This optimization also benefits single-band networks that do not require interoperation with multi-band networks.

These advantages constitute significant improvements over existing approaches, delivering enhanced efficiency, reduced complexity, and faster service recovery and initialization in optical network systems.

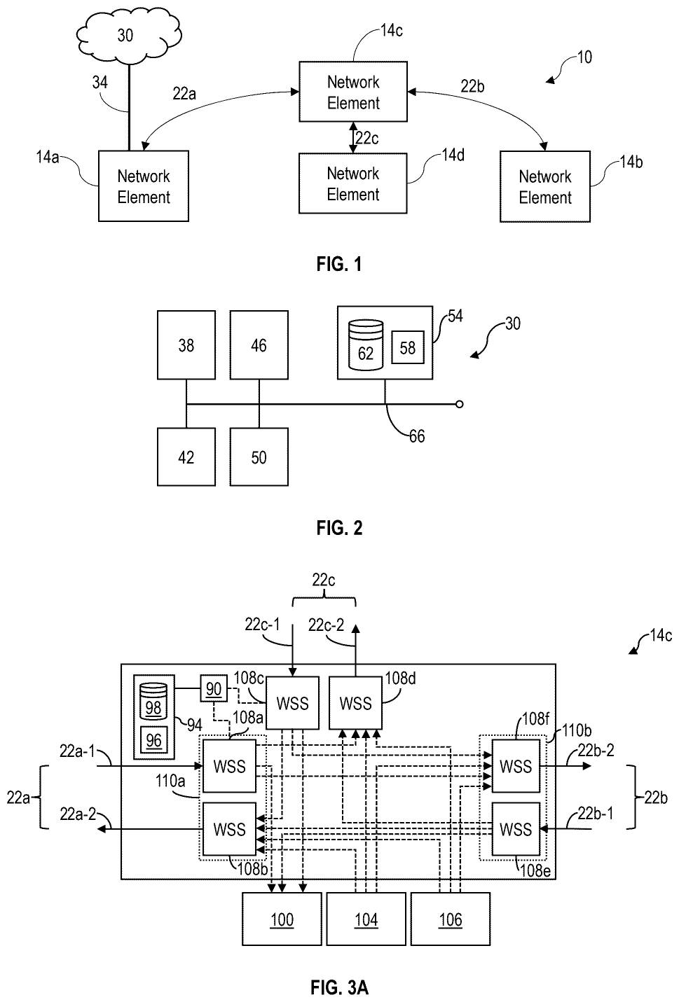

Referring now to the drawings, and in particular to FIG. 1, shown therein is a diagram of an exemplary embodiment of an optical transport network 10 constructed in accordance with the present disclosure. The optical transport network 10 is depicted as having a plurality of network elements 14a-n (hereinafter the “network elements 14” or each individually a “network element 14”) (e.g., a first network element 14a, a second network element 14b, a third network element 14c, and a fourth network element 14d shown in FIG. 1) connected via one or more optical fiber links 22a-n (hereinafter the “optical fiber links 22” or each individually an “optical fiber link 22”) (e.g., a first optical fiber link 22a, a second optical fiber link 22b, and a third optical fiber link 22c shown in FIG. 1). Though four of the network elements 14 are shown for exemplary purposes, it will be understood that the network elements 14 may comprise a number of the network elements 14 that is greater or fewer than four. Data transmitted within the optical transport network 10 from the first network element 14a to the second network element 14b may travel along an optical path formed from the first optical fiber link 22a, the third network element 14c, and the second optical fiber link 22b to the second network element 14b.

In one embodiment, a user may interact with a computer system 30, e.g., via a user device, that may be used to communicate with one or more of the network elements 14 via a communication network 34.

In some embodiments, the computer system 30 (described below in reference to FIG. 2 in more detail) may comprise a processor and a memory having a data store that may store data such as network element version information, firmware version information, sensor data, system data, metrics, logs, tracing, and the like in a raw format as well as transformed data that may be used for tasks such as reporting, visualization, analytics etc. The data store may include structured data from relational databases, semi-structured data, unstructured data, time-series data, and binary data. The data store may be a data base, a remote accessible storage, or a distributed filesystem. In some embodiments, the data store may be a component of an enterprise network.

In some embodiments, the computer system 30 is connected to one or more of the network elements 14 via the communication network 34. In this way, the computer system 30 may communicate with one or more of the network elements 14, and may, via the communication network 34, transmit or receive data from each of the network elements 14. In other embodiments, the computer system 30 may be integrated into each of the network elements 14 and/or may communicate with one or more pluggable cards within one or more of the network elements 14. In some embodiments, the computer system 30 may be a remote network element.

The communication network 34 may permit bi-directional communication of information and/or data between the computer system 30 and/or the network elements 14 of the optical transport network 10. The communication network 34 may interface with the computer system 30 and/or the network elements 14 in a variety of ways. For example, in some embodiments, the communication network 34 may interface by optical and/or electronic interfaces, and/or may use a plurality of network topographies and/or protocols including, but not limited to, Ethernet, TCP/IP, circuit switched path, combinations thereof, and/or the like. The communication network 34 may utilize a variety of network protocols to permit bi-directional interface and/or communication of data and/or information between the computer system 30 and/or the network elements 14.

The communication network 34 may be almost any type of network. For example, in some embodiments, the communication network 34 may be a version of an Internet network (e.g., exist in a TCP/IP-based network). In one embodiment, the communication network 34 is the Internet. It should be noted, however, that the communication network 34 may be almost any type of network and may be implemented as the World Wide Web (or Internet), a local area network (LAN), a wide area network (WAN), a metropolitan network, a wireless network, a cellular network, a Bluetooth network, a Global System for Mobile Communications (GSM) network, a code division multiple access (CDMA) network, a 3G network, a 4G network, an LTE network, a 5G network, a satellite network, a radio network, an optical network, a cable network, a public switched telephone network, an Ethernet network, combinations thereof, and/or the like.

If the communication network 34 is the Internet, a primary user interface of the computer system 30 may be delivered through a series of web pages or private internal web pages of a company or corporation, which may be written in hypertext markup language, JavaScript, or the like, and accessible by the user. It should be noted that the primary user interface of the computer system 30 may be another type of interface including, but not limited to, a Windows-based application, a tablet-based application, a mobile web interface, a VR-based application, an application running on a mobile device, and/or the like. In one embodiment, the communication network 34 may be connected to one or more of the user devices, computer system 30, and the network elements 14.

The optical transport network 10 may be, for example, considered as a graph made up of interconnected individual nodes (i.e., the network elements 14). If the optical transport network 10 is an optical transport network, the optical transport network 10 may include any type of network that uses light as a transmission medium. For example, the optical transport network 10 may include a fiber-optic based network, an optical transport network, a light-emitting diode network, a laser diode network, an infrared network, a wireless optical network, a wireless network, combinations thereof, and/or other types of optical networks.

The number of devices and/or networks illustrated in FIG. 1 is provided for explanatory purposes. In practice, there may be additional devices and/or networks, fewer devices and/or networks, different devices and/or networks, or differently arranged devices and/or networks than are shown in FIG. 1. Furthermore, two or more of the devices illustrated in FIG. 1 may be implemented within a single device, or a single device illustrated in FIG. 1 may be implemented as multiple, distributed devices. Additionally, or alternatively, one or more of the devices of the optical transport network 10 may perform one or more functions described as being performed by another one or more of the devices of the optical transport network 10. Devices of the computer system 30 may interconnect via wired connections, wireless connections, or a combination thereof. For example, in one embodiment, the user device and the computer system 30 may be integrated into the same device, that is, the user device may perform functions and/or processes described as being performed by the computer system 30, described below in more detail.

Referring now to FIG. 2, shown therein is a diagram of an exemplary embodiment of the computer system 30 constructed in accordance with the present disclosure. In some embodiments, the computer system 30 may include, but is not limited to, embodiments as a personal computer, a cellular telephone, a smart phone, a network-capable television set, a tablet, a laptop computer, a desktop computer, a network-capable handheld device, a server, a digital video recorder, a wearable network-capable device, a virtual reality/augmented reality device, and/or the like.

In some embodiments, the computer system 30 may include one or more input devices 38 (hereinafter the “input device 38”), one or more output devices 42 (hereinafter the “output device 42”), one or more processors 46 (hereinafter the “processor 46”), one or more communication devices 50 (hereinafter the “communication device 50”) capable of interfacing with the communication network 34, one or more non-transitory processor-readable media (hereinafter the “computer system memory 54”) storing processor-executable code and/or software application(s) 58, a database 62, for example including, a web browser capable of accessing a website and/or communicating information and/or data over a wireless or wired network (e.g., the communication network 34), and/or the like. The input device 38, the output device 42, the processor 46, the communication device 50, and the computer system memory 54 may be connected via a path 66 such as a data bus that permits communication among the components of the computer system 30.

In some embodiments, the processor 46 may comprise one or more of the processor 46 working together, or independently, to read and/or execute processor executable code and/or data, such as stored in the computer system memory 54. The processor 46 may be capable of creating, manipulating, retrieving, altering, and/or storing data structures into the computer system memory 54. Each element of the computer system 30 may be partially or completely network-based or cloud-based, and may or may not be located in a single physical location.

Exemplary embodiments of the processor 46 may include, but are not limited to, a digital signal processor (DSP), a central processing unit (CPU), a field programmable gate array (FPGA), a microprocessor, a multi-core processor, an application specific integrated circuit (ASIC), combinations, thereof, and/or the like, for example. The processor 46 may be capable of communicating with the computer system memory 54 via the path 66. The processor 46 may be capable of communicating with the input device 38 and/or the output device 42.

The processor 46 may be further capable of interfacing and/or communicating with the network elements 14 via the communication network 34 using the communication device 50. For example, the processor 46 may be capable of communicating via the communication network 34 by exchanging signals (e.g., analog, digital, optical, and/or the like) via one or more ports (e.g., physical or virtual ports) using a network protocol to provide information to the network elements 14.

The computer system memory 54 may store a software application 58 that, when executed by the processor 46, causes the computer system 30 to perform an action such as communicate with, or control, one or more components of the computer system 30, the optical transport network 10 (e.g., the network elements 14) and/or the communication network 34. The software application 58 may be an SPCO 200 or one or more service components of the SPCO 200, as described below in more detail.

In some embodiments, the computer system memory 54 may be located in the same physical location as the computer system 30, and/or one or more computer system memory 54 may be located remotely from the computer system 30. For example, the computer system memory 54 may be located remotely from the computer system 30 and communicate with the processor 46 via the communication network 34. Additionally, when more than one computer system memory 54 is used, a first computer system memory may be located in the same physical location as the processor 46, and additional computer system memory may be located in a location physically remote from the processor 46. Additionally, the computer system memory 54 may be implemented as a “cloud” non-transitory processor-readable storage memory (i.e., one or more of the computer system memory 54 may be partially or completely based on or accessed using the communication network 34).

In one embodiment, the database 62 may be a time-series database, a relational database, or a non-relational database. Examples of such databases comprise, DB2®, Microsoft® Access, Microsoft® SQL Server, Oracle®, mySQL, PostgreSQL, MongoDB, Apache Cassandra, InfluxDB, Prometheus, Redis, Elasticsearch, TimescaleDB, and/or the like. It should be understood that these examples have been provided for the purposes of illustration only and should not be construed as limiting the presently disclosed inventive concepts. The database 62 can be centralized or distributed across multiple systems.

The input device 38 may be capable of receiving information input from the user, another computer, and/or the processor 46, and transmitting such information to other components of the computer system 30 and/or the communication network 34. The input device 38 may include, but is not limited to, embodiment as a keyboard, a touchscreen, a mouse, a trackball, a microphone, a camera, a fingerprint reader, an infrared port, a slide-out keyboard, a flip-out keyboard, a cell phone, a PDA, a remote control, a fax machine, a wearable communication device, a network interface, combinations thereof, and/or the like, for example.

The output device 42 may be capable of outputting information in a form perceivable by the user, another computer system, and/or the processor 46. For example, embodiments of the output device 42 may include, but are not limited to, a computer monitor, a screen, a touchscreen, a speaker, a website, a television set, a smart phone, a PDA, a cell phone, a fax machine, a printer, a laptop computer, a haptic feedback generator, a network interface, combinations thereof, and the like, for example. It is to be understood that in some exemplary embodiments, the input device 38 and the output device 42 may be implemented as a single device, such as, for example, a touchscreen of a computer, a tablet, or a smartphone. It is to be further understood that as used herein the term “user” is not limited to a human being, and may comprise a computer, a server, a website, a processor, a network interface, a user terminal, a virtual computer, combinations thereof, and/or the like, for example.

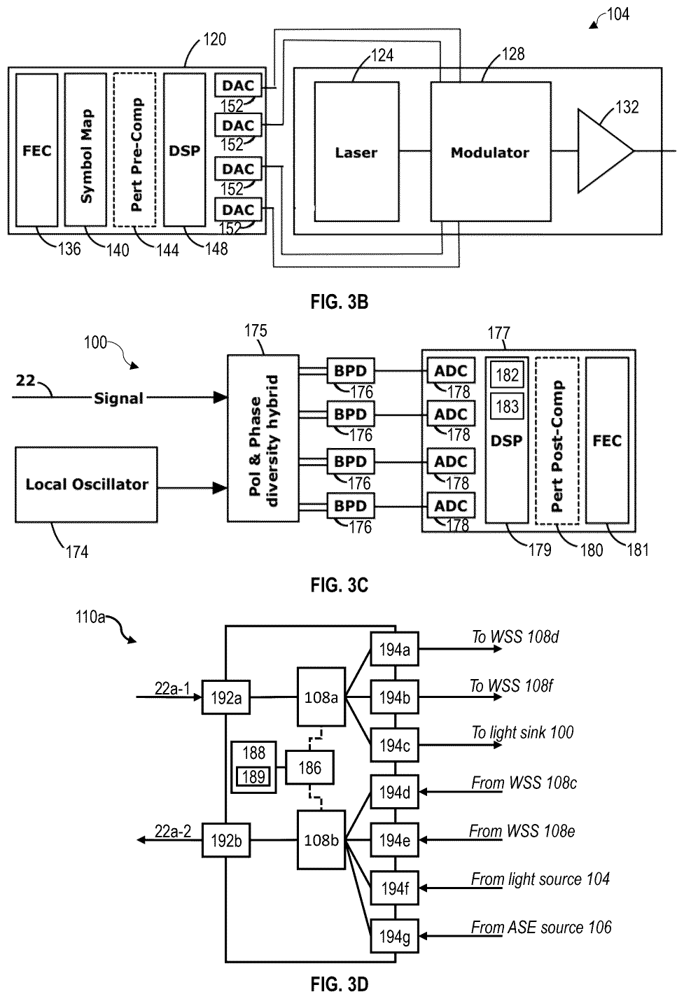

Referring now to FIG. 3A, shown therein is a block diagram of an exemplary embodiment of the network element 14 constructed in accordance with the present disclosure. In general, the network element 14 transmits and receives data traffic and control signals.

Nonexclusive examples of alternative embodiments of the network element 14 include optical line terminals (OLTs), optical cross connects (OXCs), optical line amplifiers, optical add/drop multiplexer (OADMs) and/or reconfigurable optical add/drop multiplexers (ROADMs), interconnected by way of optical fiber links. OLTs may be used at either end of a connection or optical fiber link. OADM/ROADMs may be used to add, terminate and/or reroute wavelengths or fractions of wavelengths. Optical nodes are further described in U.S. Pat. No. 7,995,921 B2, titled “Banded Semiconductor Optical Amplifiers and Waveblockers”, issued Aug. 9, 2011, U.S. Pat. No. 7,394,953 B1, titled “Configurable Integrated Optical Combiners and Decombiners”, issued Jul. 1, 2008, and U.S. Pat. No. 8,223,803 B2, titled “Programmable Time Division Multiplexed Switching,” issued Jul. 17, 2012, the entire contents of each of which are hereby incorporated herein by reference in its entirety. Because SPCO 200 is deployed on a ROADM, as used herein, the network element 14 is implemented as a ROADM unless specifically stated otherwise.

FIG. 3A illustrates an example of the third network element 14c being a ROADM that interconnects the first optical fiber link 22a, the second optical fiber link 22b, and the third optical fiber link 22c. One or more of the optical fiber links 22 may include optical fiber pairs, wherein each fiber of the pair carries optical signal groups propagating in opposite directions. As seen in FIG. 3A, for example, the first optical fiber link 22a may include a first optical fiber 22a-1—which carries optical signals toward the third network element 14c—and a second optical fiber 22a-2—which carries optical signals out from the third network element 14c. Similarly, the second optical fiber link 22b may include a third optical fiber 22b-1 and a fourth optical fiber 22b-2 carrying optical signal groups to and from the third network element 14c, respectively. Further, the third optical fiber link 22c may include a fifth optical fiber 22c-1 and a sixth optical fiber 22c-2 also carrying optical signals to and from the third network element 14c, respectively. Additional nodes, not shown in FIG. 3A, may be provided that supply optical signal groups to and receive optical signal groups from the third network element 14c. Such nodes may also have a ROADM having the same or similar structure as that of the third network element 14c.

As further shown in FIG. 3A, a light sink 100 and a light source 104 may be provided and in communication with the third network element 14c to drop and add optical signal groups, respectively. The light sink 100 is described below in more detail and shown in FIG. 3B. The light source 104 is described below in more detail and shown in FIG. 3C. Optionally, an ASE source 106 may be provided and in communication with the third network element 14c. The ASE source 106 may be configured to generate ASE noise.

As shown in FIG. 3A, the third network element 14c may include a plurality of wavelength selective switches (WSSs) 108a-n (hereinafter the “WSSs 108” or each individually a “WSS 108”) (e.g., a first WSS 108a, a second WSS 108b, a third WSS 108c, a fourth WSS 108d, a fifth WSS 108e, and a sixth WSS 108f shown in FIG. 3A). WSSs are components that can dynamically route, block and/or attenuate received optical signal groups input from and output to the optical fiber links 22. In addition to transmitting/receiving optical signal groups from the network elements 14, optical signal groups may also be input from or output to the light source 104 and the light sink 100, respectively.

In one embodiment, the WSSs 108 for a particular degree, along with the associated FRM memory 188 and the FRM processor 186 (shown in FIG. 3D), may be collectively referred to as a flexible ROADM module (FRM) 110. For example, as shown in FIG. 3A, the first WSS 108a and the second WSS 108b may be part of a first FRM 110a, and the sixth WSS 108f and the fifth WSS 108e may be part of a third FRM 110c (collectively the “FRMs 110”).

In one embodiment, each of the WSSs 108 may include a reconfigurable, optical filter operable to allow a passband (e.g., particular bandwidth of the spectrum of the optical signal) to pass through or be routed as herein described.

As further shown in FIG. 3A, each of the WSSs 108 can receive optical signal groups (e.g., optical passbands) and may be operable to selectively switch, or direct, such optical signal groups to others of the WSSs 108 for output from the third network element 14c. For example, the first WSS 108a may receive optical signal groups on the first optical fiber 22a-1 and supply certain optical signal groups to the sixth WSS 108f, while others are supplied to the fourth WSS 108d. Those supplied to the sixth WSS 108f may be output to a downstream network element 14, such as the second network element 14b (FIG. 1) on the fourth optical fiber 22b-2, while those supplied to the fourth WSS 108d may be output to the fourth network element 14d on the sixth optical fiber 22c-2. Also, optical signal groups input to the third network element 14c on the third optical fiber 22b-1 may be supplied by the fifth WSS 108e to either the second WSS 108b and on to the first network element 14a via the second optical fiber 22a-2 or the fourth WSS 108d and on to the fourth network element 14d via the sixth optical fiber 22c-2. Moreover, the third WSS 108c may selectively direct optical signal groups (e.g., selectively switch optical passband groups) input to the third network element 14c from the fifth optical fiber 22c-1 to either the second WSS 108b and onto the first network element 14a via the second optical fiber 22a-2 or to the sixth WSS 108f and onto the second network element 14b via the fourth optical fiber 22b-2.

The first WSS 108a, the third WSS 108c, and the fifth WSS 108e may also selectively or controllably supply optical signal groups to the light sink 100 and optical signal groups may be selectively output from the light source 104 in the third network element 14c. The optical signal groups output from the light source 104 may be selectively supplied to one or more of the second WSS 108b, the fourth WSS 108d, and the sixth WSS 108f, for output on to the second optical fiber 22a-2, the fourth optical fiber 22b-2, and the sixth optical fiber 22c-2, respectively.

In one embodiment, the third network element 14c may further comprise a node processor 90 and a non-transitory computer readable medium 94 (also referred to herein as a “node memory”). The node processor 90 may include, but is not limited to, a digital signal processor (DSP), a central processing unit (CPU), a field programmable gate array (FPGA), a microprocessor, a multi-core processor, an application specific integrated circuit (ASIC), combinations, thereof, and/or the like, for example. The node processor 90 is in communication with the node memory 94 and may be operable to read and/or write to the node memory 94. The node processor 90 may be capable of communicating with one or more of the WSSs 108 (shown as in communication with the third WSS 108c and the first WSS 108a for simplicity, however, the node processor 90 may be in communication with each WSS 108) or each of the FRMs 110. The node processor 90 may be further capable of interfacing and/or communicating with the network elements 14 via the communication network 34. For example, the node processor 90 may be capable of communicating via the communication network 34 by exchanging signals (e.g., analog, digital, optical, and/or the like) via one or more ports (e.g., physical or virtual ports) using a network protocol to provide information to the network elements 14.

In one embodiment, the node memory 94 of the network element 14, such as of the third network element 14c, may store a software application 96, such as an orchestrator application (e.g., the SPCO 200 or one or more service components of the SPCO 200 such as the orchestrator 202, described below in more detail) that, when executed by the node processor 90, causes the node processor 90 to perform an action, for example, communicate with or control one or more components of the network element 14 such as control one or more of the WSS 108 or the FRM 110.

In one embodiment, the node memory 94 may store one or more of the datastore 98. The datastore 98 may include, for example, structured data from relational databases, semi-structured data, unstructured data, time-series data, binary data, and the like and/or some combination thereof. The datastore 98 may be a data base, a remote accessible storage, or a distributed filesystem. In some embodiments, the datastore 98 may be a component of an enterprise network.

Referring now to FIG. 3B, shown therein is a diagram of an exemplary embodiment of the light source 104 of FIG. 3A constructed in accordance with the present disclosure. The light source 104 may comprise one or more transmitter processor circuits 120, one or more lasers 124, one or more modulators 128, one or more semiconductor optical amplifiers 132, and/or other components (not shown). The light source 104 may transmit client data modulated in the form of optical light pulses, which may be considered a form of “optical content” as described herein.

The transmitter processor circuit 120 may have a Transmitter Forward Error Correction (FEC) circuitry 136, a Symbol Map circuitry 140, a transmitter perturbative pre-compensation circuitry 144, one or more transmitter digital signal processor (DSP) 148, and one or more digital-to-analogue converters (DAC) 152. The transmitter processor circuit 120 may be located in any one or more components of the light source 104, or separate from the components, and/or in any location(s) among the components. The transmitter processor circuit 120 may be in the form of one or more Application Specific Integrated Circuits (ASICs), which may contain one or more modules and/or custom modules.

Processed electrical outputs from the transmitter processor circuit 120 may be supplied to the modulator 128 for encoding data into optical signals generated and supplied to the modulator 128 from the laser 124. The semiconductor optical amplifier 132 receives, amplifies, and transmits the optical signal including encoded data in the spectrum. Processed electrical outputs from the transmitter processor circuit 120 may be supplied to other circuitry in the transmitter processor circuit 120, for example, clock and data modification circuitry. The laser 124, modulator 128, and/or semiconductor optical amplifier 132 may be coupled with a tuning element (e.g., a heater) (not shown) that can be used to tune the wavelength of an optical signal channel output by the laser 124, modulator 128, or semiconductor optical amplifier 132. In some embodiments, a single one of the laser 124 may be shared by multiple light source 104.

Other possible components in the light source 104 may include filters, circuit blocks, memory, such as non-transitory memory storing processor executable instructions, additional modulators, splitters, couplers, multiplexers, etc., as is well known in the art. The components may be combined, used, or not used, in multiple combinations or orders. Optical transmitters are further described in U.S. Patent Publication No. 2012/0082453, the content of which is hereby incorporated by reference in its entirety herein.

Referring now to FIG. 3C, shown therein is a block diagram of an exemplary embodiment of the light sink 100 constructed in accordance with the present disclosure. The light sink 100 may comprise one or more local oscillators 174, a polarization and phase diversity hybrid circuit 175 receiving the one or more channels from the optical signal and the input from the local oscillator 174, one or more balanced photodiodes 176 that produces electrical signals representative of the one or more channels on the spectrum, and one or more processor circuits 177. Other possible components in the light sink 100 may include filters, circuit blocks, memory, such as non-transitory processor-readable memory storing processor-executable instructions, additional modulators, splitters, couplers, multiplexers, etc., as is well known in the art. The components may be combined, used, or not used, in multiple combinations or orders. The light sink 100 may be implemented in other ways, as is well known in the art. Exemplary embodiments of the light sink 100 are further described in U.S. patent application Ser. No. 12/052,541, titled “Coherent Optical Receiver”, the entire contents of which are hereby incorporated by reference. The light sink 100 may receive the client data modulated in the form of optical light pulses, which may be considered a form of “optical content” as described herein.

The one or more receiver processor circuits 177 may comprise one or more analog-to-digital converters (ADCs) 178 receiving the electrical signals from the balanced photodiodes 176, one or more receiver digital signal processors (DSPs) 179, receiver perturbative post-compensation circuitry 180, and receiver forward error correction (FEC) circuitry 181. The receiver FEC circuitry 181 may apply corrections to the data, as is well known in the art. The one or more receiver processor circuits 177 and/or the one or more receiver DSPs 179 may be located on one or more components of the light sink 100 or separately from the components, and/or in any location(s) among the components. The receiver processor circuit 177 may be in the form of an Application Specific Integrated Circuit (ASIC), which may contain one or more modules and/or custom modules. In one embodiment, the receiver DSP 179 may include, or be in communication with, one or more processors 182 and one or more memories 183 storing processor readable instructions, such as software, or may be in communication with the node processor 90 and the node memory 94.

The one or more receiver DSPs 179 may receive and process the electrical signals with multi-input-multiple-output (MIMO) circuitry, as described, for example, in U.S. Pat. No. 8,014,686, titled “Polarization demultiplexing optical receiver using polarization oversampling and electronic polarization tracking”, the entire contents of which are hereby incorporated by reference herein. Processed electrical outputs from receiver DSP 179 may be supplied to other circuitry in the receiver processor circuit 177, such as the receiver perturbative post-compensation circuitry 180 and the receiver FEC circuitry 181.

Various components of the light sink 100 may be provided or integrated, in one example, on a common substrate. Further integration is achieved by incorporating various optical demultiplexer designs that are relatively compact and conserve space on the surface of the substrate.

In use, the one or more channels of the spectrum may be subjected to optical non-linear effects between the light source 104 and the light sink 100 such that the spectrum received does not accurately convey carried data in the form that the spectrum was transmitted. The impact of optical nonlinear effects can be partially mitigated by applying perturbative distortion algorithms using one or more of the transmitter perturbative pre-compensation circuitry 171 and the receiver perturbative post-compensation circuitry 180. The amount of perturbation may be calculated using coefficients in algorithms and known or recovered transmitted data. The coefficients may be calculated, in accordance with U.S. Pat. No. 9,154,258 entitled “Subsea Optical Communication System Dual Polarization Idler”, herein incorporated by reference in its entirety, by use of analysis of one or more incoming channel at the light sink 100.

Referring now to FIG. 3D, shown therein is a diagram of an exemplary embodiment of the first FRM 110a constructed in accordance with the present disclosure. The first FRM 110a generally comprises a FRM processor 186 in communication with a FRM memory 188, the first WSS 108a, and the second WSS 108b. The first WSS 108a is in optical communication with a first line port 192a operable to receive the optical signal from the first optical fiber 22a-1 and is in optical communication with two or more system ports 194 (shown in FIG. 3D as a first system port 194a, a second system port 194b, and a third system port 194c) to selectively output one or more passbands to one or more of the system ports 194. The second WSS 108b is in optical communication with a second line port 192b operable to output an optical signal to the optical fibers 22a-b and is in optical communication with two or more system ports 194 (shown in FIG. 3D as fourth system port 194d, fifth system port 194e, sixth system port 194f, and seventh system port 194g) to selectively output one or more passbands to the second line port 192b. In one embodiment, the first WSS 108a (as well as other wavelength selective switches demultiplexing an incoming optical signal such as the third WSS 108c and the fifth WSS 108e) may be considered a DEMUX WSS and the second WSS 108b (as well as other wavelength selective switches multiplexing one or more incoming optical signals into an optical signal output to an optical fiber link 22, such as the fourth WSS 108d and the sixth WSS 108f) may be considered a MUX WSS. The number of components illustrated in FIG. 3D is provided for explanatory purposes. In practice, there may be additional components, such as one or more EDFAs, fewer components, different components, and/or differently arranged components than shown in FIG. 3D.

In one embodiment, each of the system ports 194a-n may have a port type of either an express port or an add/drop port. For example, the first system port 194a, optically coupled to the fourth WSS 108d, and the second system port 194b, optically coupled to the sixth WSS 108f, may have a port type of express port and may be considered express ports, while the third system port 194c, optically coupled to the light sink 100, may have a port type of add/drop port and may be considered a drop port. Similarly, the fourth system port 194d, optically coupled to the third WSS 108c, and the fifth system port 194e, optically coupled to the fifth WSS 108e, may have a port type of express port and may be considered express ports, while the sixth system port 194f, optically coupled to the light source 104, may have a port type of add/drop port and may be considered an add port, and the seventh system port 194g, optically coupled to the ASE source 106, may have a port type of add/drop port and may be considered an add port.

In one embodiment, the first FRM 110a is a C-Band FRM, that is, the components of the first FRM 110a operate on the C-Band of the optical spectrum. In other embodiments, the first FRM 110a is an L-Band FRM, that is, the components of the first FRM 110a operate on the L-Band of the optical spectrum. In yet another embodiment, the first FRM 110a is a C+L-Band FRM having components that operate on the C-Band and the L-Band. The number of devices illustrated in FIG. 3D is provided for explanatory purposes. In practice, there may be additional devices, fewer devices, different devices, or differently arranged devices than are shown in FIG. 3D. Furthermore, two or more of the devices illustrated in FIG. 3D may be implemented within a single device, or a single device illustrated in FIG. 3D may be implemented as multiple, distributed devices. For example, the C+L-Band FRM may comprise an L-Band FRM optically coupled to a C-Band FRM.

In one embodiment, the FRM memory 188 may be constructed in accordance with the computer system memory 54 and/or the node memory 94 as described above in more detail. The FRM memory 188 may comprise a non-transitory processor-readable medium storing processor-executable instructions such as a FRM software application 189. The FRM software application 189 includes instructions that, when executed by the FRM processor 186, cause the FRM processor 186 to control the first WSS 108a and/or the second WSS 108b.

In a first aspect, an incoming optical signal having multiple optical channels enters the first line port 192a via the first optical fiber 22a-1 and is directed to the first WSS 108a. The incoming optical signal is split into one or more segments by the first WSS 108a, each segment having one or more optical channel. The one or more segments of the incoming optical signal are then directed to one or more system port 194a-c, for example, the first WSS 108a may direct one or more segment to one or more of the fourth WSS 108d via the first system port 194a, the sixth WSS 108f via the second system port 194b, and/or the light sink 100 via the third system port 194c.

In a second aspect, a first incoming optical signal enters the fourth system port 194d, a second incoming optical signal enters the fifth system port 194e, a third incoming optical signal enters the sixth system port 194f, and an ASE noise signal enters the seventh system port 194g, and each incoming optical signal or ASE noise signal is directed to the second WSS 108b. The second WSS 108b, as directed by the FRM processor 186, may combine the first incoming optical signal, the second incoming optical signal, the third incoming optical signal, and the ASE noise signal into a combined optical signal that is sent on the second optical fiber 22a-2 via the second line port 192b. For example, the second WSS 108b may receive the first incoming optical signal from the third WSS 108c via the fourth system port 194d, the second incoming optical signal from the fifth WSS 108e via the fifth system port 194e, the third incoming optical signal from the light source 104 via the sixth system port 194f, and the ASE noise signal from the ASE source 106 via the seventh system port 194g.

While each of the above aspects and the illustration of the first WSS 108a and the second WSS 108b in FIG. 3D show the first WSS 108a and the second WSS 108b with only three of the system ports 194, a person having ordinary skill in the art would recognize that the first WSS 108a and the second WSS 108b may have as few as two system ports 194 and as may system ports 194 as the WSS 108 is operable to selectively output or combine. In some embodiments, each WSS 108 may have any number of system ports 194 in a range of 2 and 16 system ports 194.

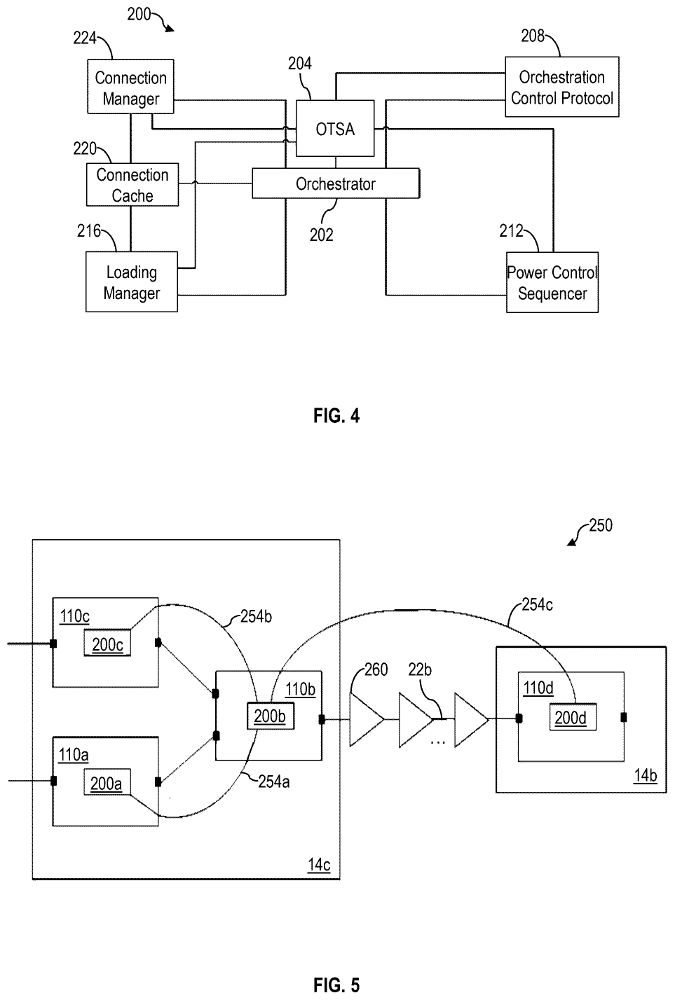

Referring now to FIG. 4, shown therein is a software architecture diagram of an exemplary embodiment of a Service and Power Control Orchestrator (SPCO) 200 constructed in accordance with the present disclosure. As previously described, the SPCO 200 and/or one or more service component of the SPCO 200 may be, or be part of, the software application 58 stored on the computer system memory 54 of the computer system 30 (FIG. 2); and/or the SPCO 200 and/or one or more service component of the SPCO 200 may be, or be part of, the software application 96 stored on the node memory 94 of the network element(s) 14 (FIG. 3A); and/or the SPCO 200 and/or one or more service component of the SPCO 200 may be, or be part of, the FRM software application 189 stored on the FRM memory 188 of the FRM(s) 110 (FIG. 3D).

An exemplary embodiment of the SPCO 200 is described in U.S. Patent Publication No. 2023/0261749 A1, titled “Service and Power Control Orchestrator”, filed Feb. 2, 2023, and published Aug. 17, 2023, the entire contents of each of which are hereby incorporated herein by reference in their entirety.

Generally, the SPCO 200 comprises, or interfaces with, one or more service components such as an orchestrator 202, an optical topology and switching abstraction (OTSA) component 204, an orchestration control protocol (OCP) 208, a power control sequencer (PCS) 212, a loading manager (LDM) 216, a connection cache 220, and a connection manager 224. While the aforementioned service components are shown in FIG. 4, the SPCO 200 may interface with additional service components not shown. Generally, the SPCO 200 is a software component operable to sequence the optical power control functions such that an optical service is turned-up (activated) or turned-down (deactivated) without any transients being introduced on the optical signal of a C+L band network domain. In other words, the SPCO 200 may generate one or more service loading sequence. The service loading sequence may be the sequence that the optical service is activated or deactivated. In one embodiment, the SPCO 200 determines when a specific optical power control loop function should be executed and in what sequence, e.g., as a workflow.

In one embodiment, the SPCO 200 is responsible for sequencing of local power control functions and link level optical power control functions on a particular one of the network element 14 into a power control operation sequence (PCO sequence) such that power control operations are executed in a correct sequence. Generally, sequencing of local power control functions and link level optical power control functions may be delegated to one or more service component, such as the PCS 212.

In one embodiment, the SPCO 200 is responsible for network-wide service activation and deactivation such that the risk of transients and/or SRS tilt in the optical signal is mitigated. Generally, network-wide activation and deactivation function may be delegated to one or more service component, such as the OCP 208.

In one embodiment, the SPCO 200 is responsible for passband fault handling including signaling of passband level fault indications to dependent downstream segments such that corresponding DEMUX SPCO and MUX SPCO deactivate affected passbands, e.g., passbands experiencing one or more passband fault.

In one embodiment, the SPCO 200 is responsible for automation of controlled operations functions such as Card Locks and Cold Resets. Card locks and cold resets should only be carried out after deactivation of services configured on that particular network element or component such that other services sharing a particular one of the optical fiber link 22 with the deactivated service(s) do not experience transients.

In one embodiment, the SPCO 200 is responsible for automation of fault recovery functions such that, on recovery of the fault, services impacted by the fault are re-activated without causing transients on any part of the optical transport network 10.

In one embodiment, the orchestrator 202 is implemented in software. The orchestrator 202 coordinates with each of the service components of the SPCO 200. The orchestrator 202, by coordinating with each service component, achieves optical service turn-up/turn-down through orchestration of power control functions. In one embodiment, the orchestrator 202 tracks passband level finite state machines (FSMs) to pick an appropriate workflow to be executed. As used herein, the workflow is a set of one or more tasks executed by the SPCO 200 to load one or more optical service, e.g., to perform one or more loading operation such as activation or deactivation of optical services. Additionally, passband level FSMs may include passband level states such as up or down status (e.g., is the passband activated or deactivated), shutdown status, active status and fault status and/or the like. In one embodiment, the orchestrator 202 is operable to interface between one or more requestor (entity requesting an optical service activation and/or deactivation) and actual optical service activation and/or deactivation on a C+L band network domain.

In one embodiment, the orchestrator 202 serves as a central point with respect to all decisions within the SPCO 200. For example, the orchestrator 202 may determine when to issue a loading request to a control block or a PCO request (i.e., a power control operation request) to a downstream ROADM, or to signal a passband's loading state in the OCP 208. In one embodiment, the orchestrator 202 may delegate orchestration functionality to one or more service component as described below. For example, optimizing passband batches may be delegated to the LDM 216 and PCO requests, service loading request, and/or passband loading requests may be delegated to the PCS 212. Additionally, in some embodiments, the orchestrator 202 may delegate inter-node communications to the OCP 208, topology related configuration details are provided by the OTSA 204, and connection related details are provided by the connection manager 224.

In one embodiment, the OTSA 204 may be an optical topology and switching abstraction model. The OTSA 204 may be a logical ROADM model or a logical FRM model, for example. The OTSA 204 may serve as a central repository of logical ROADM model.

In one embodiment, the OTSA 204 may be implemented in software and provide an application programming interface (API) operable to receive a request for the logical ROADM model and provide at least a portion of the logical ROADM model to the requestor.

In one embodiment, the OTSA 204 may be implemented in software and provide a subscription service operable to receive a subscription request from a particular service component, and, when the logical ROADM model is updated, the OTSA 204 may notify the particular service component of the change.

In one embodiment, the OCP 208 may be implemented in software and manages network level coordination of power control functions. Generally, the OCP 208 may perform one or more of the following: neighbor adjacency management; handle requests from the orchestrator 202 for service activation or service deactivation on one or more local one of the WSS 108; handle a neighbor's request for service activation or service deactivation on one or more local one of the WSS 108; handle passband state notifications; periodically refresh passband activation states; synchronize local and neighbor node restarts; and aid in recovery of neighbor node after a communication failure/restart.

In one embodiment, the OCP 208 may be implemented as described in the U.S. Patent Application No. 63/305,758 entitled “Orchestration Control Protocol”, filed Feb. 2, 2022, the entire contents of which are hereby incorporated herein in their entirety.

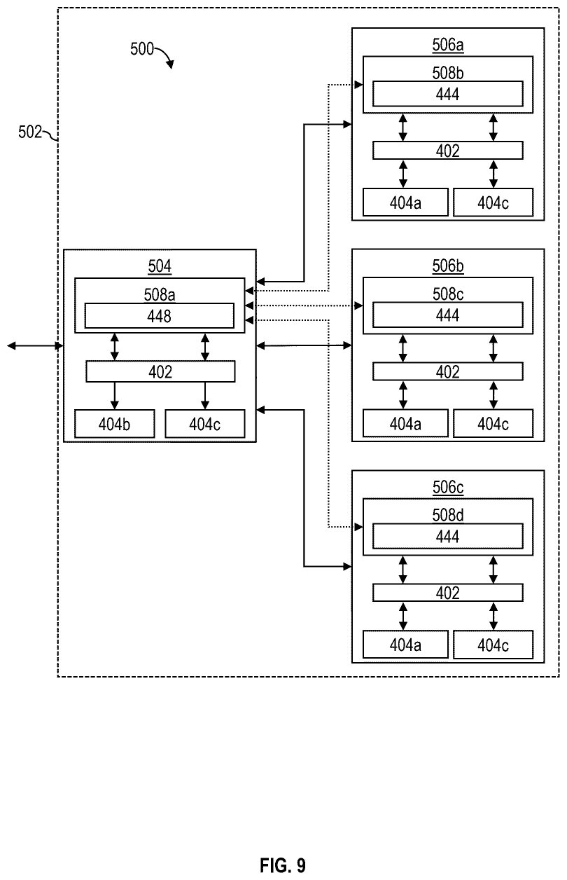

In one embodiment, the PCS 212 may be implemented in software and is operable to sequence optical power control operations. When the orchestrator 202 requests that the PCS 212 perform a power control operation request (PCO request), the PCS 212 generates an ordered list of power control operations to be carried out. In some embodiments, the PCS 212 further executes the ordered list of power control operations. In one embodiment, the PCS 212 utilizes one or more platform-specific component Power Control Agent (PCA) to execute the ordered list of power control operations. In one embodiment, the PCS 212 may further consolidate and report the state of each control block 404 (described below). In one embodiment, the PCS 212 may interface with one or more WSS MUX Control (MCL) power control block, WSS DEMUX Control (DMCL) power control block; and/or link level optical power control block. In one embodiment, a PCA may be a C-Band PCA or an L-Band PCA. The C-Band PCA may provide a composite view of a MUX control block 404a (FIG. 9), a DEMUX control block 404b (FIG. 9), and a link level optical power control block while the L-Band PCA may provide a composite view of just the MUX control block 404a and the DEMUX control block 404b. In one embodiment, each PCA may abstract power control modules and provide a generic interface operable to receive one or more communication from the SPCO 200.

In one embodiment, the PCS 212 fetches and stores control block information for one or more control block 404 from the OTSA 204. The PCS 212 may determine which PCO should be executed on which control block 404 based on the PCO request from the orchestrator 202. In one embodiment, the PCS 212 may generate a dependency graph for each PCO request by decomposing the PCO request into one or more PCO. The dependency graph may represent a dependency relationship among the PCOs in the PCO request and therefore may determine a sequencing or execution order of the PCOs in the PCO request.

In one embodiment, the PCA may be a software component hosted on each line card (e.g., FRM 110) and act as an interface between the PCS 212 and the one or more control blocks 404. The PCS 212 may communicate with each PCA via a unique namespace identifying that PCA. In one embodiment, the PCS 212 utilizes a dedicated thread pool to delegate the execution of PCOs to appropriate PCAs. Because the orchestrator 202 of the SPCO 200 communicates with the PCA via the PCS 212, the orchestrator 202 and the SPCO 200 may be considered location independent, that is, the SPCO 200 and the orchestrator 202 may be deployed at one or more of the line card level (i.e., on an FRM 110) or on a controller card in a network element 14 (e.g., on the node memory 94 accessible by the node processor 90).

In one embodiment, the PCA may provide an aggregated view of one or more control block 404 and provides access to the control blocks 404 to perform power control operations (PCOs) and to retrieve a control status (as described below). In one embodiment, asynchronous updates from control blocks 404 may be channeled via the PCA, through the PCS 212 to the orchestrator 202. The PCA may aggregate one or more control status into one report and transmit that report to the orchestrator 202 as herein described.

In one embodiment, the LDM 216 may be implemented in software and may be operable to manage loading operations (such as service activation and/or service deactivation) on a degree-based loading policy. In some embodiments, the degree-based loading policy may be predefined, however, in other embodiments, the degree-based loading policy may be user provisioned.

In one embodiment, the LDM 216 may be implemented as described in U.S. Patent Publication No. 2023/0247334 A1, titled “Grouping of Optical Passbands for Loading in an Optical Transmission Spectrum Using an Affinity Identifier”, filed Dec. 27, 2022, and published Aug. 3, 2023, in U.S. Patent Publication No. 2023/0224039 A1, titled “User Configurable Spectral Loading in an Optical Line System using Policies and Parameters”, filed Dec. 27, 2022, and published Jul. 13, 2023, or in U.S. Patent Publication No. 2023/0327762 A1, titled “Method of Transient Management in Optical Transmission Systems”, filed Apr. 7, 2023, and published Oct. 12, 2023, the entire contents of each of which are hereby incorporated herein in their entirety.

In one embodiment, the orchestrator 202 may send one or more request to the LDM 216 to cause the LDM 216 to apply the loading policy on one or more passband to be activated and/or deactivated on a particular degree. The LDM 216 may further generate one or more batch of passbands to be activated and/or deactivated. In one embodiment, the one or more batch is an ordered sub-set of the one or more passband to be activated and/or deactivated on the particular degree.

In one embodiment, the connection cache 220 may be implemented in software and may be operable to provide a cache API. The cache API may be operable to receive a request querying connection information and in response to the query, provide one or more information of the connection information. The connection information may be a single source of “truth” for service components. The connection cache 220 may store the activation state of the passbands and, thus, associated connections. The cache API may be queried from one or more perspective, such as, for example, a service perspective, a passband perspective, and/or a carrier perspective.

In one embodiment, the connection manager 224 may be implemented in software and is operable to manage provisioning of one or more optical service within the SPCO 200. In some embodiments, the connection manager 224 manages provisioning of all optical services within the SPCO 200. In one embodiment, each optical service may be either a manual optical connection or a signaled optical circuit through the Generalized Multiprotocol Label Switching (GMPLS) layer.

In one embodiment, the connection manager 224 may send one or more signal to the connection cache 220 operable to update connection information stored in and/or by the connection cache 220. In one embodiment, the connection manager 224 may send one or more signal to the orchestrator 202 indicative of one or more connection operation being (or to be) carried out. When the orchestrator 202 receives the signal, the orchestrator 202 may load passband information pertaining to the one or more connection operation and operate on the passband information, e.g., transmit the passband information to one or more service component such as the LDM 216. In one embodiment, the connection manager 224 may consolidate one or more state, such as an Activation State, at the connection level.

In one embodiment, the SPCO 200 and one or more service component of the SPCO 200 may be implemented as software and stored on a non-transitory processor-readable medium, such as one or more of the computer system memory 54, the node memory 94, and/or the FRM memory 188. The software may be one or more of the software application 58 of the computer system 30, the software application 96 of the network element(s) 14, and/or the FRM software application 189. In one embodiment, the SPCO 200 may be implemented on a shelf controller or node controller such as on the computer system memory 54 and executed by the processor 46 of the computer system 30, may be implemented on the network element 14 (e.g., a ROADM) such as on the node memory 94 and executed by the node processor 90, and/or implemented on an FRM 110 such as on the FRM memory 188 and executed by the FRM processor 186.

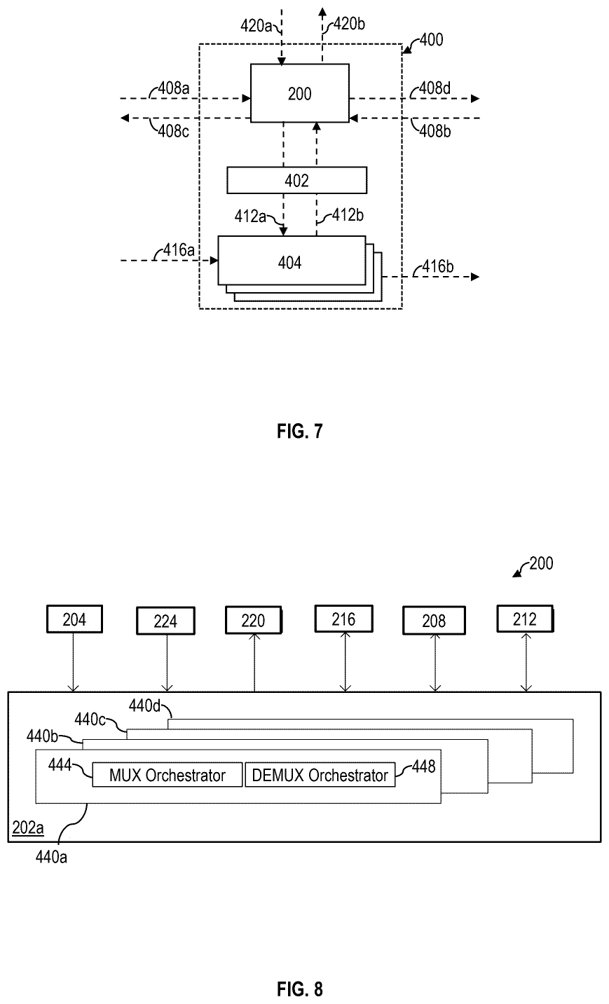

In one embodiment, when the SPCO 200 is implemented on the FRM 110, e.g., the third FRM 110c, for example, the service components of the SPCO 200 may have one or more defined interactions. For example, the connection manager 224 and the OTSA 204 may interact with an SPCO agent of a management layer (described below in reference to FIG. 7); the OTSA 204 may interact with a neighbor detection protocol executing on the base card; the OCP 208 may interact with a neighbor message handler; and the PCS 212 may interact with the power control agent on either the base or an expansion card (as described below in more detail).

In one embodiment, the neighbor discovery protocol, which performs neighbor associate, may be constructed as described in the U.S. patent application Ser. No. 18/152,440 entitled “Systems and Methods for Network Element Neighbor Discovery”, filed Jan. 10, 2022, the entire contents of which are hereby incorporated herein in their entirety. In one embodiment, the neighbor message handler is a platform-specific software component operable to exchange messages with adjacent ROADMs (as described below in reference to FIG. 7).

In one embodiment, when the SPCO 200 is deployed on all degrees of a ROADM, e.g., all FRM 110 of a network element 14, the SPCO 200 forms adjacency with neighboring SPCO 200 instances, e.g., a deployed instance of the SPCO 200 on other degrees of a same one of the network element 14 and/or with one or more SPCO 200 deployed on a neighboring network element 14. Referring now to FIG. 5, shown therein is a diagram of an exemplary embodiment of an adjacency graph 250 of the third network element 14c constructed in accordance with the present disclosure.

As shown in FIG. 5, the third network element 14c is optically coupled to the second network element 14b via the second optical fiber link 22b. The third network element 14c includes a first SPCO 200a deployed on the first FRM 110a, a second SPCO 200b deployed on the second FRM 110b, and a third SPCO 200c deployed on the third FRM 110c. The second network element 14b includes a fourth SPCO 200d deployed on a fourth FRM 110d. Further shown in FIG. 5 is one or more in-line optical component 260 optically disposed on the second optical fiber link 22b intermediate the third network element 14c and the second network element 14b. The in-line optical component 260 may be, for example, one or more of an in-line optical amplifier, a variable optical attenuator (VOA), an erbium-doped fiber amplifier (EDFA), and/or the like.

In one embodiment, the second SPCO 200b, deployed on the second FRM 110b forms a neighbor association with neighboring SPCO 200 instances. As shown in FIG. 5, the second SPCO 200b forms a first neighbor association 254a with the first SPCO 200a deployed on the first FRM 110a and a second neighbor association 254b with the third SPCO 200c deployed on the third FRM 110c. Each of the first neighbor association 254a and the second neighbor association 254b may be considered an intra-node neighbor association because each of the associated FRM 110 (e.g., the first FRM 110a and the third FRM 110c) are components of the same node as the second FRM 110b, i.e., the third network element 14c. The second SPCO 200b may further form a third neighbor association with the fourth SPCO 200d deployed on the fourth FRM 110d of the second network element 14b. The third neighbor association 254c may be considered an inter-node (or inter-degree) neighbor association because the associated FRM 110 (e.g., the fourth FRM 110d) is a component of a different node from the second FRM 110b, i.e., the fourth FRM 110d is on the second network element 14b while the second FRM 110b is on the third network element 14c. It should be noted that while the third neighbor association 254c is shown between the second SPCO 200b on the second FRM 110b and the fourth SPCO 200d on the fourth FRM 110d, the third neighbor association 254c may be between the second SPCO 200b on the second FRM 110b and an SPCO 200 deployed on a downstream ROADM from the second FRM 110b, such as on the node memory 94 of the second network element 14b and/or on the or the computer system memory 54 associated with the second network element 14b.

As described above, the SPCO 200 and one or more service component of the SPCO 200 may be implemented as software and deployed at any level of the optical transport network 10, e.g., deployed on a chassis or site level in the computer system memory 54, deployed at the node level in the node memory 94, and/or deployed at the FRM or line card level in the FRM memory 188. In order for the SPCO 200 to operate and function at each level without requiring the SPCO 200 to be recompiled for each specific level, functions at each level are abstracted to maintain consistent behavior of the SPCO 200. In this way, the SPCO 200 and all service components of the SPCO 200 use a generic optical topology and switching abstraction to carry out functions, thereby enabling the SPCO 200 to be reusable across different levels and platforms. Because a physical realization of the abstract topology is necessary, i.e., services are actually activated and/or deactivated, mapping between components of the abstract topology and the physical counterparts is established as well.

In this way, communication between distributed deployments of the SPCO 200a-d across multiple network elements 14 in the optical transport network 10 and within each network element 14 across each degree achieves network level orchestration. By deploying the SPCO 200 on each network element 14, dedicated orchestration hardware external to the network element 14 is not needed and may be omitted. Additionally, if a particular SPCO 200 were to fail, orchestration functionality may be maintained by adjacent SPCO 200 instances. In some embodiments, within a degree level deployment (e.g., the SPCO 200 being deployed on a particular FRM 110), orchestration functions and associated optical power control blocks are co-located on the same FRM processor 186 thereby providing faster and more reliable local interactions (e.g., interactions between the SPCO 200 and one or more component of the FRM 110). Moreover, fault monitoring, detection, handling, and recovery processes can be sped up as these processes are localized.

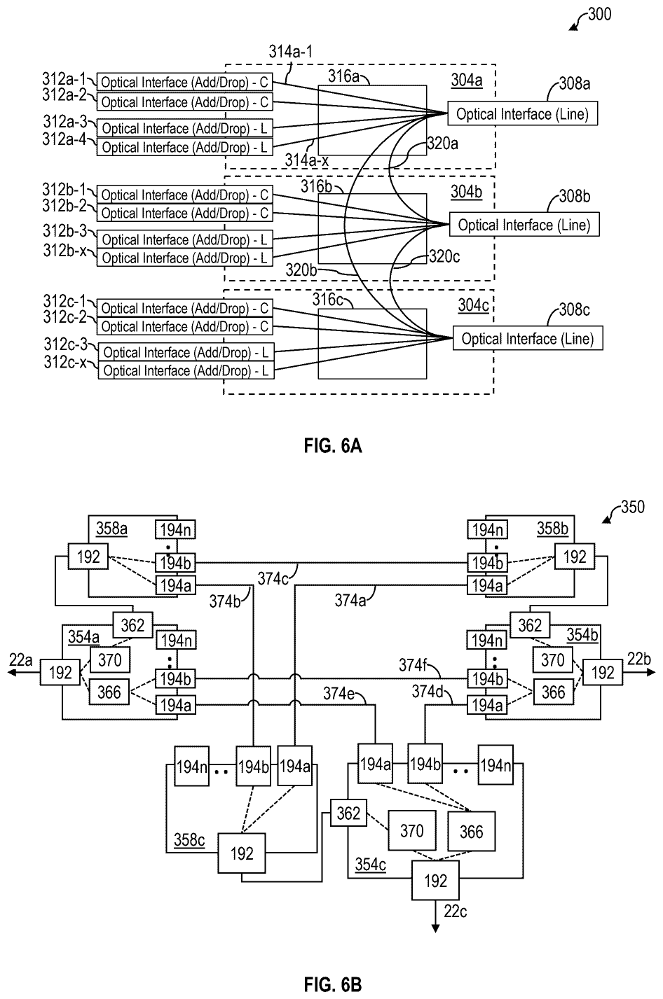

Referring now to FIG. 6A, shown therein is a functional diagram of an exemplary embodiment of a logical ROADM model 300 constructed in accordance with the present disclosure. The logical ROADM model 300 shown in FIG. 6A is a logical representation of an ‘n’-degree ROADM described below in more detail in FIG. 6B and is described as a three-degree ROADM for brevity and simplicity. As shown, the logical ROADM model 300 generally comprises one or more logical FRM model 304a-n (illustrated as a first logical FRM model 304a, a second logical FRM model 304b, and a third logical FRM model 304c). Each logical FRM model 304 generally comprises a logical line port 308 logically linked to one or more logical system port via a connectivity matrix 316.

As shown in FIG. 6A, the first logical FRM model 304a comprises a first logical line port 308a logically coupled via logical connections 314a-1 through 314a-x (e.g., add/drop connection) to a plurality of system ports 312a-1 through 312a-x via a first connectivity matrix 316a; the second logical FRM model 304b comprises a second logical line port 308b logically coupled to a plurality of system ports 312b-1 through 312b-x via a second connectivity matrix 316b; and the third logical FRM model 304c comprises a third logical line port 308c logically coupled to a plurality of system ports 312c-1 through 312c-x via a third connectivity matrix 316c.

The logical ROADM model 300 represents an Optical Switching Framework (OSF) in which switching is defined between a pair of interfaces, such as a line port and one or more system port. As discussed above, each ROADM consists of one or more degrees/FRMs and each degree/FRM consists of a group of optical interfaces, such as a line port and one or more system port. A connectivity between each optical interface (e.g., the logical line ports 308 and the logical system ports 312) is defined in the connectivity matrix 316.

In one embodiment, as discussed above, each system port 194 has a port type of either add/drop port or express port. When a particular system port 194 has a port type of add/drop port, the particular system port 194 interfaces directly with client signals. The client signals may be either connected directly to the line port or multiplexed in one or more stages into an optical signal supplied to the line port. The optical interface model of the logical system ports 312 of the particular system port 194 subsumes the multiplexing hierarchy associated with the client signals entering the ROADM.

In one embodiment, when a particular system port 194 has a port type of express port, the particular system port 194 provides direct express connectivity from one ROADM instance to another, typically co-located within the same site and may be connected via a patch cable when within the same chassis or may be connected via one or more waveguide when within the same node. The optical interface model of the logical system port 312 having an express port type (not shown) of the particular system port 194 subsumes the direct express connectivity. As shown in FIG. 6A, logical system ports 312 having an express port type are not modeled for inter-degree/inter-node connectivity but are instead shown as a cross-connection 320 (discussed below).

In one embodiment, the line port 192 provides for optical communication with a component external to the ROADM such as for optical communication with a ROADM instance located at a different site, e.g., a downstream network element 14. The logical line port 308 is an optical interface model for the line port 192.

In one embodiment, each connectivity matrix 315 described connectivity between pairs of optical interfaces, such as the logical line port 308 and one or more logical system port 312. A cross-connection 320 from a first optical interface to a second optical interface may be completed if the cross-connection 320 is defined in the connectivity matrix 316. The cross-connection 320 may define connectivity both between add/drop ports and line ports, and between express ports and line ports 192 when the logical ROADM model 300 includes more than one logical line port 308. For example, as shown in FIG. 6B, a first cross-connection 320a, defined in the first connectivity matrix 316a and the second connectivity matrix 316b as an express connection, is shown between the first logical line port 308a and the second logical line port 308b and a second cross-connection 320b, defined in the first connectivity matrix 316a as an express connection, is shown between the logical system port 312a-1 and the first logical line port 308a.

In one embodiment, each cross-connection 320 is unidirectional while the optical connection is bidirectional because a first state of the FRM 110 operating in a first degree is independent of a second state of the FRM 110 operating in a second degree. In this embodiment, with the logical ROADM model 300 modeling each cross-connection 320 in a first direction (e.g., from an upstream node to a downstream node), a second logical ROADM model may be created for a second direction opposite the first direction (e.g., from the downstream node to the upstream node).

In one embodiment, each optical interface supports one of C-Band, Extended-C-Band, Super-C-Band, L-Band, Super-L-Band, C+L-Band, or Super-C+Super-L-Band.

In some embodiments, only line ports 192 (and thus logical line ports 308) support C+L-Band while system ports 194 (and thus logical system ports 312) support either C-Band or L-Band, but not C+L-Band. In this embodiment, separate entries in the connectivity matrix 316 may be defined for C-Band connectivity (i.e., from a C-Band FRM 354, described below) and L-Band connectivity (i.e., from an L-Band FRM 358, described below). For example, a first connectivity entry may be defined in the first connectivity matrix 316a for connectivity of the first logical system port 312a-1 supporting the C-Band, while a second connectivity entry may be defined in the first connectivity matrix 316a for connectivity of the third logical system port 312a-3 supporting the L-Band. In this way, each logical FRM model 304 of the logical ROADM model 300 is a consolidation of functions of the C-Band FRM 354 and the L-Band FRM 358.

Referring now to FIG. 6B, shown therein is a block diagram of an exemplary embodiment of a physical topology of a ROADM 350 constructed in accordance with the present disclosure. Generally, the ROADM 350 includes a C-Band FRM 354 and an L-Band FRM 358 for each degree. As shown in exemplary FIG. 6B, the ROADM 350 includes a first L-Band FRM 358a coupled to a first C-Band FRM 354a, and a second L-Band FRM 358b coupled to a second C-Band FRM 354b, and a third L-Band FRM 358c coupled to a third C-Band FRM 354c. The ROADM 350 of FIG. 6B is shown as a three-degree ROADM, however, the ROADM 350 may have more than three degrees or fewer than three degrees.

In one embodiment, the first L-Band FRM 358a generally comprises a plurality of system ports 194a-n selectably optically coupled to the line port 192. The line port 192 of the first L-Band FRM 358a is optically coupled to an expansion port 362 of the first C-Band FRM 354a. The first C-Band FRM 354a generally comprises a plurality of system ports 194a-n selectably optically coupled to a C-Band connection termination point (e.g., a C-Band CTP 366) and the expansion port 362 is optically coupled to an L-Band CTP 370. The C-Band CTP 366 and the L-Band CTP 370 are optically combined and coupled to the line port 192 of the first C-Band FRM 354a. The line port 192 of the first C-Band FRM 354a may be coupled to an optical fiber link 22 such as the first optical fiber link 22a, for example. As used here, a connection termination point (or CTP) is a logical connection termination point.

In one embodiment, as shown in FIG. 6B, an express connection 374 is formed connecting at least one system port 194 of each L-Band FRM 358 to each other L-Band FRM 358. For example, as shown, a first express connection 374a optically links the first system port 194a of the second L-Band FRM 358b and the first system port 194a of the third L-Band FRM 358c, a second express connection 374b optically links the first system port 194a of the first L-Band FRM 358a and the second system port 194b of the third L-Band FRM 358c, and a third express connection 374c optically links the second system port 194b of the first L-Band FRM 358a and the second system port 194b of the second L-Band FRM 358b.

In one embodiment, as shown in FIG. 6B, an express connection 374 is formed connecting at least one system port 194 of each C-Band FRM 354 to each other C-Band FRM 354. For example, as shown, a fourth express connection 374d optically links the first system port 194a of the second C-Band FRM 354b and the second system port 194b of the third C-Band FRM 354c, a fifth express connection 374e optically links the first system port 194a of the first C-Band FRM 354a and the first system port 194a of the third C-Band FRM 354c, and a sixth express connection 374f optically links the second system port 194b of the first C-Band FRM 354a and the second system port 194b of the second C-Band FRM 354b.

In one embodiment, the second L-Band FRM 358b and the second C-Band FRM 354b are generally constructed and coupled similar to the first L-Band FRM 358a and the first C-Band FRM 354a as described above. Similarly, the third L-Band FRM 358c and the third C-Band FRM 354c are generally constructed and coupled similar to the first L-Band FRM 358a and the first C-Band FRM 354a as described above.

Referring back to FIG. 6A, in combination with FIG. 6B, in one embodiment, each connectivity matrix 316 may be applied to a ROADM 350 to abstract physical ports of the ROADM 350 into logical ports of the logical ROADM model 300. For example, the first connectivity matrix 316a may abstract the line port 192 of the first C-Band FRM 354a, the line port 192 of the third C-Band FRM 354c, the first system port 194a of the first L-Band FRM 358a, the second system port 194b of the third L-Band FRM 358c, the first system port 194a of the first C-Band FRM 354a, and the first system port 194a of the third C-Band FRM 354c into the second cross-connection 320b. Additionally, the first connectivity matrix 316a may abstract the line port 192 of the first C-Band FRM 354a, the line port 192 of the second C-Band FRM 354b, the second system port 194b of the first L-Band FRM 358a, the second system port 194b of the second L-Band FRM 358b, the second system port 194b of the first C-Band FRM 354a, and the second system port 194b of the second C-Band FRM 354b into the first cross-connection 320a.

Similarly, the second connectivity matrix 316b may abstract the line port 192 of the second C-Band FRM 354b, the line port 192 of the third C-Band FRM 354c, the first system port 194a of the second L-Band FRM 358b, the first system port 194a of the third L-Band FRM 358c, the first system port 194a of the second C-Band FRM 354b, and the second system port 194b of the third C-Band FRM 354c into the third cross-connection 320c. Additionally, the second connectivity matrix 316b may abstract the line port 192 of the second C-Band FRM 354b, the line port 192 of the first C-Band FRM 354a, the second system port 194b of the second L-Band FRM 358b, the second system port 194b of the first L-Band FRM 358a, the second system port 194b of the second C-Band FRM 354b, and the second system port 194b of the first C-Band FRM 354a into the first cross-connection 320a.

Further, the third connectivity matrix 316c may abstract the line port 192 of the third C-Band FRM 354c, the line port 192 of the first C-Band FRM 354a, the first system port 194a of the first L-Band FRM 358a, the second system port 194b of the third L-Band FRM 358c, the first system port 194a of the first C-Band FRM 354a, and the first system port 194a of the third C-Band FRM 354c into the second cross-connection 320b. Additionally, the third connectivity matrix 316c may abstract the line port 192 of the second C-Band FRM 354b, the line port 192 of the third C-Band FRM 354c, the first system port 194a of the second L-Band FRM 358b, the first system port 194a of the third L-Band FRM 358c, the first system port 194a of the second C-Band FRM 354b, and the second system port 194b of the third C-Band FRM 354c into the third cross-connection 320c.

Referring now to FIG. 7, shown therein is a functional model of an exemplary embodiment of an optical services and power controls subsystem 400 (hereinafter the “subsystem 400”), constructed in accordance with the present disclosure. In some embodiments, as shown in FIG. 7, the subsystem 400 is an embodiment of the software application 58 of the computer system 30, the software application 96 of the network element(s) 14, and/or the FRM software application 189 described above and operable to perform an action such as communicate with or control one or more component of the computer system 30, the optical transport network 10 (e.g., one or more of the network elements 14) and/or the communication network 34.

In one embodiment, the subsystem 400 of FIG. 7 is implemented on a ROADM and comprises the SPCO 200, a power control agent (PCA) 402 and one or more control block 404. The one or more control block 404 may be operable to control one or more component of the network element 14 via an optical power control-related configuration of the optical transport network 10 (i.e., by adjusting one or more attenuation level and/or one or more gain associated with the network element 14) such that a target optical power level in the optical fiber link 22 is maintained within a tolerance level of optimal levels all of the time. Maintaining such a target optical power level may have the effect of guaranteeing that receiving equipment (i.e., a light sink 100 of a receiving network element 14) receives a higher-quality signal with a good Signal-to-Noise Ratio (SNR) and with minimal distortion. In one embodiment, each of the one or more control block 404 may be associated with one or more component of the ROADM. For example, referring to FIG. 6B, one or more first control block 404 may be associated with the C-Band FRM 354 and one or more second control block 404 may be associated with the L-Band FRM 358. In one embodiment, the SPCO 200 deployed on the C-Band FRM 354 can control the L-Band FRM 358 coupled thereto.

In some embodiments, the SPCO 200 is operable to control one or more optical power control-related configuration of the network element 14 and/or the control block 404 thereof, via the PCA 402. In one embodiment, exemplary components of the network element 14 controlled by one or more control block 404 includes a WSS, an EDFA, an optical channel monitor, a variable optical attenuator, a Raman pump, and other optical devices, for example. In one embodiment, the control blocks 404 may be specific to the component of the network element 14 the SPCO 200 is deployed to, and, in some embodiments, may be product dependent. For example, optical functions and topology for the network element components are usually modelled as a second level expansion of the logical ROADM model 300 (described below). The optical components are primarily used to carry out optical power control functions on the associated equipment. Additionally, because power control functions are delegated to existing local controls (e.g., input power controls (INPC), MCL and DMCL) and link level optical power controls, the SPCO 200 and/or the orchestrator 202 are not required to model fined grained optical topology; however, the SPCO 200 and/or orchestrator 202 do need to know what optical control blocks are supported in on the platform in which the SPCO 200 is deployed.

Each control block 404 may comprise at least one of a MUX control block 404a operable to control one or more optical power control-related configuration of a MUX WSS, a DEMUX control block 404b operable to control one or more optical power control-related configuration of a DEMUX WSS, and a link control block 404c operable to control one or more link level optical power such as optical power control-related configuration of one or more optical amplifier (OA) and/or variable optical attenuator (VOA) and/or in the optical fiber link 22.

In one embodiment, the MUX control block 404a may adjust one or more passband configuration and/or one or more attenuation of the “MUX” WSSs. Such adjustments may be made by the MUX control block 404a on a per-passband basis. In one embodiment, the DEMUX control block 404b may adjust one or more passband configuration and/or one or more attenuation of the “DEMUX” WSSs. Such adjustments may be made by the DEMUX control block 404b on a per-passband basis. In some embodiments, the functions of the MUX control block 404a and the DEMUX control block 404b may be performed by a single control block 404.

In one embodiment, the link control block 404c may adjust one or more configuration, one or more attenuation, and/or one or more gain for one or more in-line optical component 260 (such as the optical amplifier (OA) and/or variable optical attenuator (VOA) in the optical fiber link 22). Such adjustments may be made on a per-band basis (i.e., the C-band, the L-band, or C/L-band).

In one embodiment, each control block 404 exposes one or more functionalities, including common functionalities, such as ‘sync control block’ and ‘get status of control block’. Other functionalities may be exposed based on the type of the control block. For example, the MUX control block 404a and the DEMUX control block 404b may expose functionalities including ‘activate passband request’, ‘deactivate passband request”, ‘block passband request”, ‘enable adjustment request”, ‘disable adjustment request”, and/or the like. The link control block 404c may expose ‘adjust gain request”, ‘enable gain adjust request”, ‘disable gain adjust request”, ‘activate band request”, ‘deactivate band request”, and/or the like. In one embodiment, the PCA 402 operates as a standardized (or abstracted) interface for exposing the above functionalities of individual control blocks 404 to the SPCO 200. For example, the PCS 212 may also send update from the PCA (via a notification channel) regarding one or more of a control block state such as a ‘state update’, ‘passband state update’, ‘band info update’, ‘link control update’, and/or the like.

In some embodiments, the SPCO 200 is operable to control one or more optical power control-related configuration of the control blocks 404 via the PCA 402. For example, the SPCO 200 may send one or more PCO request and/or loading request to the PCA 402. Additionally, the SPCO 200 may receive one or more PCO response, loading response, passband state, and/or control block state from the PCA 402. In the case that the SPCO 200 sends a loading request to the PCA 402 (e.g., to activate and/or deactivate a group of passbands), the PCA 402 translates abstracted commands of the loading request to hardware commands for the control blocks 404. The control block 404 may then act on the loading request, perform activation and/or deactivation for a group of passbands, and sends the loading response to the PCA 402, which receives the loading response and converts the loading response to a logical abstraction accessible by the orchestrator 202 and/or SPCO 200, e.g., in conjunction with the OTSA 204. In some embodiments, the control block 404 may also send one or more state update for the passbands in the group of passbands, a state of the control block 404 pertaining to power control loop functionality, and/or other supplementary information such as state of one of the one or more bands and/or an optical fiber link state.

In one embodiment, the SPCO 200 may be operable to receive and/or send an inter-node communication 408, e.g., to upstream and/or to downstream ROADMs and/or network elements 14. For example, the SPCO 200 may receive a first inter-node communication 408a from an upstream direction, may receive a second inter-node communication 408b from a downstream direction, may send a third inter-node communication 408c in the upstream direction, and may send a fourth inter-node communication 408d in the downstream direction. Such orchestration may have the effect of minimizing the impact the SRS tilt effect has on pre-existing optical services in the optical transport network 10. For example, the SPCO 200 may be operable to receive and/or send the inter-node communication 408 to one or more of an upstream orchestrator application (e.g., an SPCO 200 operating on an upstream network element) or a downstream orchestrator application operating on a downstream network element.

In one embodiment, each of the inter-node communications 408 may be one or more of a PCO request 412a, a passband loading state, a PCO response 412b, a passband loading status, and/or a health status update.

In some embodiments, the PCA 402 may transmit PCO requests 412a to the control block(s) 404 and may receive PCO responses 412b and/or health status updates from the control block(s) 404. In one embodiment, each PCO request 412a originates from an upstream ROADM (e.g., via the first inter-node communication 408a). When the orchestrator 202 of the SPCO 200 receives the PCO request 412a from the first inter-node communication 408a, the SPCO 200 issues the PCO request 412a to the PCA 402 which, in turn, transmits the PCO request 412a to a particular control block 404. The particular control block 404 may act on the PCO request 412a and transmit the PCO response 412b back towards the orchestrator 202. The SPCO 200 may then send a consolidated PCO response back to the upstream ROADM, e.g., via the third inter-node communication 408c. The PCO request 412a may be one or more of a disable adjust request, Mux WSS control adjustment request, adjust link control request, and/or an enable adjustment request.

In one embodiment, the PCO request 412a is a disable adjust request issued by an orchestrator deployed on the upstream ROADM to the SPCO 200 to disable automatic WSS and link level optical power controls. The disable adjust request further suspends local loading on all mux degrees. When the SPCO 200 receives the disable adjust request and transmits the disable adjust request to the MUX control block 404a on all dependent mux degrees, the MUX control block 404a stores a reference power level.

In one embodiment, the PCO request 412a is a Mux WSS controls adjust request issued by an orchestrator on the upstream ROADM to the SPCO 200 to adjust cause the mux WSS to meet a reference power level in a MUX control block 404a for all dependent express services on all dependent mux degrees.

In one embodiment, the PCO request 412a is an adjust link control request issued by an orchestrator on the upstream ROADM to the SPCO 200 to adjust link amplifier controls in a link control block 404c to meet an optical power target on all dependent mux degrees.

In one embodiment, the PCO request 412a is an enable adjust request issued by an orchestrator on the upstream ROADM to the SPCO 200 to enable autonomous WSS and link level optical power controls (e.g., suspend optical power adjustments, enable optical power adjustments, etc.) in the MUX control block 404a and the link control block 404c running on all dependent mux modules. Further, it enables loading on all dependent mux degrees.

In one embodiment, the PCO request 412a may originate from the orchestrator on the upstream ROADM where passband loading is performed and sent to the SPCO 200 through the OCP 208. The OCP 208, in turn, ensures that the PCO request 412a is sent to the orchestrator 202, which, in turn, sends the PCO request 412a to the control block 404 via the PCA 402. In one embodiment, once, the SPCO 200 sends the consolidated PCO response the upstream ROADM, the OCP 208 again ensures that the PCO response 412b is transmitted to the orchestrator on the upstream ROADM.

In one embodiment, each control block 404 may send and/or receive controls data 416. For example, the control block 404 may receive upstream controls data 416a from an upstream network element 14 and may transmit downstream controls data 416b to a downstream network element 14. The controls data 416 may include one or more data indicative of one or more of an optical power value, an SNR value, a carrier density, an ASE value, and/or the like.

In one embodiment, the SPCO 200 may receive service control requests and/or configuration information 420a from a northbound layer and may transmit service status information 420b to the northbound layer. In some embodiments, the northbound layer may be a management layer, for example.

Referring now to FIG. 8, shown therein is a block diagram of an exemplary embodiment of the SPCO 200 implemented on a ROADM and constructed in accordance with the present disclosure. The SPCO 200 comprises a first orchestrator 202a constructed in accordance with the orchestrator 202 as detailed above and refers to the orchestrator 202 when stored as the software application 96 of the network element 14 and/or the FRM software application 189 in the node memory 94 or the FRM memory 188, and executed by the node processor 90 or the FRM processor 186, respectively. As shown, the first orchestrator 202a is implemented on a ROADM and is composed of and orchestrates activities of one or more degree orchestrator 440a-n (shown as first, second, third, and fourth degree orchestrators 440a through 440d), while each degree orchestrator 440a-d operates independently of each other degree orchestrator 440a-n.

In one embodiment, each degree orchestrator 440a-n is constructed in accordance with the orchestrator 202 with the exception that the degree orchestrator 440a-n is in communication with the OTSA 204 to receive the logical FRM model 304 as an FRM abstraction type while the first orchestrator 202a is in communication with the OTSA 204 to receive the logical ROADM model 300 and the logical FRM model 304 for each degree of a ROADM as a ROADM abstraction type. In one embodiment, when the first orchestrator 202a is running on an FRM 110, the first orchestrator 202a would include only one degree orchestrator 440. The OTSA 204 reports an abstraction type (e.g., FRM/degree abstraction associated with the logical FRM model or a ROADM abstraction associated with the logical ROADM model) with degree provisioning to the first orchestrator 202a.

In one embodiment, each degree orchestrator 440 comprises a MUX orchestrator 444 and a DEMUX orchestrator 448. In one embodiment, the MUX orchestrator 444 orchestrates activities of outgoing optical signals, such as ingress to the optical fiber link 22 including any line amplifier controls (e.g., implemented in link level optical power control in link control blocks 404c) and multiplexer WSS controls, such as in MUX control blocks 404a. Conversely, the DEMUX orchestrator 448 orchestrates activities of incoming optical signals, such as ingress to the FRM 110 from the optical fiber link 22 and including any receiver line amplifier controls (e.g., implemented in link level optical power control in link control blocks 404c) and demultiplexer WSS controls such as in DEMUX control blocks 404b.

In one embodiment, each of the MUX orchestrator 444 and the DEMUX orchestrator 448 maintain a passband state, e.g., a passband level FSM, with respect to orchestration based at least in part on a passband state in MUX control blocks 404a and DEMUX control blocks 404b. In one embodiment, and based on the passband state, each of the MUX orchestrator 444 and the DEMUX orchestrator 448 make loading related decisions and/or delegate loading related decisions to one or more other service component of the SPCO 200.

Referring now to FIG. 9, shown therein is a control diagram of an exemplary embodiment of an orchestrator network 500 constructed in accordance with the present disclosure. The orchestrator network 500 deployed within a ROADM 502. The ROADM 502 generally comprises a DEMUX subsystem 504 optically coupled to one or more MUX subsystems 506a-n (hereinafter the “MUX subsystems 506”) (e.g., a first MUX subsystem 506a, a second MUX subsystem 506b, and a third MUX subsystem 506c shown in FIG. 9). The DEMUX subsystem 504 and the MUX subsystems 506 may be constructed in accordance with the subsystem 400 described above. The DEMUX subsystem 504 comprises a first SPCO 508a having the DEMUX orchestrator 448 in communication with the PCA 402. The PCA 402 in the DEMUX subsystem 504 is in communication with the DEMUX control block 404b and the link control block 404c in the DEMUX subsystem 504. The first MUX subsystem 506a comprises a second SPCO 508b having the MUX orchestrator 444 in communication with the PCA 402. The PCA 402 in the first MUX subsystem 506a is in communication with the MUX control block 404a and the link control block 404c in the first MUX subsystem 506a. The second MUX subsystem 506b comprises a third SPCO 508c having the MUX orchestrator 444 in communication with the PCA 402. The PCA 402 in the second MUX subsystem 506b is in communication with the MUX control block 404a and the link control block 404c in the second MUX subsystem 506b. And, the third MUX subsystem 506c comprises a fourth SPCO 508d having the MUX orchestrator 444 in communication with the PCA 402. The PCA 402 in the third MUX subsystem 506c is in communication with the MUX control block 404a and the link control block 404c in the third MUX subsystem 506c.

The first SPCO 508a, the second SPCO 508b, the third SPCO 508c, and the fourth SPCO 508d may each be constructed in accordance with the SPCO 200 as described above in more detail. Each of the SPCOs 508 along with the DEMUX subsystem 504 and/or the MUX subsystems 506 may be deployed at an FRM 110 for each degree of the ROADM, that is, for each degree of the ROADM 502, the SPCO 508 may be deployed to the FRM 110 associated with that degree, e.g., the SPCO 508 may be stored in the FRM memory 188 as the FRM software application 189 and executed by the FRM processor 186.

In one embodiment, as shown in FIG. 9, the ROADM 502 is an express ROADM such as the third network element 14c with the exception that the ROADM 502 is a four-degree ROADM. Further, the DEMUX subsystem 504 may be operable to control and/or manage the first WSS 108a of the third network element 14c, the first MUX subsystem 506a may be operable to control and/or manage the fourth WSS 108d of the third network element 14c, and the second MUX subsystem 506b may be operable to control and/or manage the sixth WSS 108f of the third network element 14c. Additionally, the third MUX subsystem 506c may be operable to control and/or manage any of the second WSS 108b, the fourth WSS 108d, and the sixth WSS 108f with the exception that the third MUX subsystem 506c is associated with a different degree than that of any of the second WSS 108b, the fourth WSS 108d, and the sixth WSS 108f.

In one embodiment, within the DEMUX subsystem 504, the DEMUX orchestrator 448, which is part of the first SPCO 508a, works as an overlay over the receive direction (e.g., the de-mux direction) of the optical controls, that is, the first SPCO 508a works as an overlay over the receive line amplifier controls (e.g., in the link control block 404c in the DEMUX subsystem 504) and the DEMUX control block 404b. And, within each MUX subsystem 506, the MUX orchestrator 444, which is part of the SPCO 508 in each MUX subsystem 506, works as an overlay over the transmit direction (e.g., the mux direction) of the optical controls, that is, the SPCO 508 in each MUX subsystem 506, works as an overlay over the transmit line amplifier controls (e.g., link control block 404c) and the MUX control block 404a.

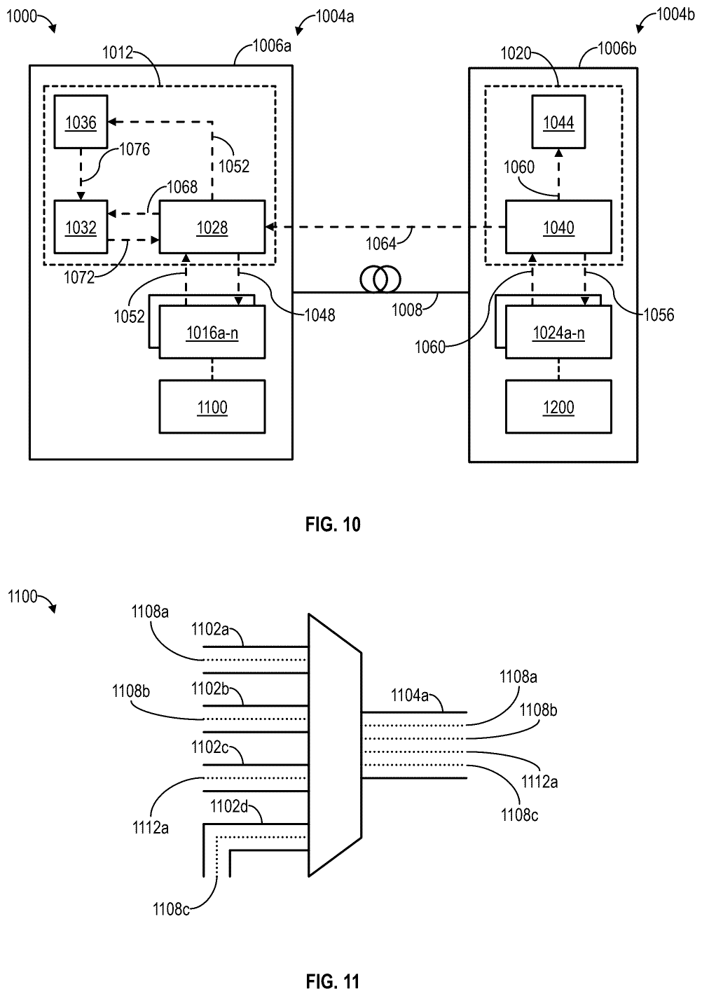

Referring now to FIG. 10, shown therein is a block diagram of an exemplary embodiment of an optical transport network segment 1000 (hereinafter the “network segment 1000”) constructed in accordance with the present disclosure. As shown in FIG. 10, the network segment 1000 may comprise a local network element 1004a and a downstream network element 1004b coupled to each other via an optical fiber link 1008. In some embodiments, the local network element 1004a and the downstream network element 1004b may be constructed in accordance with the network elements 14 or the ROADM 350 described above. In some embodiments, the optical fiber link 1008 may be constructed in accordance with the optical fiber links 22 described above.

The local network element 1004a may comprise a local MUX subsystem 1006a, which may comprise a local MUX SPCO 1012 and one or more local MUX control blocks 1016a-n (hereinafter the “local MUX control blocks 1016” or each individually a “local MUX control block 1016”). In some embodiments, the local MUX subsystem 1006a may be constructed in accordance with the MUX subsystem 506 or the WSSs 108 described above. In some embodiments, the local MUX SPCO 1012 may be constructed in accordance with the SPCOs 200 described above. In some embodiments, the local MUX control blocks 1016 may be constructed in accordance with the MUX control block 404a described above. Additionally, as described in more detail below, the local MUX subsystem 1006a may be operable to control and/or manage a local MUX WSS 1100.

The local MUX SPCO 1012 may comprise a local MUX orchestrator 1028, a local MUX loading manager 1032, and a local MUX connection cache 1036. In some embodiments, the local MUX orchestrator 1028 may be constructed in accordance with the orchestrator 202 described above. In some embodiments, the local MUX loading manager 1032 may be constructed in accordance with the loading manager 216 described above. In some embodiments, the local MUX connection cache 1036 may be constructed in accordance with the connection cache 220 described above.

The downstream network element 1004b may comprise a downstream DEMUX subsystem 1006b, which may comprise a downstream DEMUX SPCO 1020 and one or more downstream DEMUX control blocks 1024a-n (hereinafter the “downstream DEMUX control blocks 1024” or each individually a “downstream DEMUX control block 1024”). In some embodiments, the downstream DEMUX subsystem 1006b may be constructed in accordance with the DEMUX subsystem 504 or the WSSs 108 described above. In some embodiments, the downstream DEMUX SPCO 1020 may be constructed in accordance with the SPCOs 200 described above. In some embodiments, the downstream DEMUX control blocks 1024 may be constructed in accordance with the DEMUX control block 404b described above. Additionally, as described in more detail below, the downstream DEMUX subsystem 1006b may be operable to control and/or manage a downstream DEMUX WSS 1200.

The downstream DEMUX SPCO 1020 may comprise a downstream DEMUX orchestrator 1040 and a downstream DEMUX connection cache 1044. In some embodiments, the downstream DEMUX orchestrator 1040 may be constructed in accordance with the orchestrator 202 described above. In some embodiments, the downstream DEMUX connection cache 1044 may be constructed in accordance with the connection cache 220 described above.

Referring now to FIG. 11, the local MUX WSS 1100 may be in optical communication with one or more MUX tributary ports 1102a-n (hereinafter the “MUX tributary ports 1102” or each individually a “MUX tributary port 1102”) (also referred to herein as “MUX system ports”) (e.g., a first MUX tributary port 1102a, a second MUX tributary port 1102b, a third MUX tributary port 1102c, and a fourth MUX tributary port 1102d shown in FIG. 11) and one or more MUX line ports 1104a-n (hereinafter the “MUX line ports 1104” or each individually a “MUX line port 1104”) (e.g., a first MUX line port 1104a shown in FIG. 11).

The local MUX WSS 1100 may receive optical content via at least one of the MUX tributary ports 1102 for transmission over the optical fiber link 1008. As used herein, “optical content” may include one or more signal passbands 1108a-n n (hereinafter the “signal passbands 1108” or each individually a “signal passband 1108”) (e.g., a first signal passband 1108a, a second signal passband 1108b, and a third signal passband 1108c shown in FIG. 11) configured to carry client data and/or one or more ASE passbands 1112a-n (hereinafter the “ASE passbands 1112” or each individually an “ASE passband 1112”) (e.g., a first ASE passband 1112a shown in FIG. 11) configured to be filled with ASE noise, such as ASE noise generated by the ASE source 106, for example. As described above, the client data may originate from the light source 104.

The local MUX WSS 1100 may be generally operable to selectively route the optical content between the MUX tributary ports 1102 and the MUX line ports 1104 to selectively activate and deactivate the signal passbands 1108 and the ASE passbands 1112 for transmission of the optical content via the MUX line ports 1104 over the optical fiber link 1008. In the embodiment shown in FIG. 11, the local MUX WSS 1100 receives the first signal passband 1108a having a first frequency range λ₁ via the first MUX tributary port 1102a, the second signal passband 1108b having a second frequency range λ₂ via the second MUX tributary port 1102b, the first ASE passband 1112a having a third frequency range λ₃ via the third MUX tributary port 1102c, and the third signal passband 1108c having a fourth frequency range λ₄ via the fourth MUX tributary port 1102d. Further, in the embodiment shown in FIG. 11, the local MUX WSS 1100 transmits, via the first MUX line port 1104a, the first signal passband 1108a, the second signal passband 1108b, the third signal passband 1108c, and the first ASE passband 1112a.

In the embodiment shown in FIG. 11, the fourth MUX tributary port 1102d is depicted as an add port configured to be coupled to a source of the signal passbands 1108 (e.g., the light source 104) to receive the signal passbands 1108 for transmission via the first MUX line port 1104a over the optical fiber link 1008. However, it should be understood that a number of the MUX tributary ports 1102 implemented as add ports configured to be coupled to a source of the signal passbands 1108 (e.g., the light source 104) may be greater or fewer than one. Further, it should be understood that one or more of the MUX tributary ports 1102 may be implemented as an add port configured to be coupled to a source of the ASE passbands 1112 (e.g., the ASE source 106) to receive the ASE passbands 1112 for transmission via the first MUX line port 1104a over the optical fiber link 1008.

Referring back to FIG. 10, in order to either activate or deactivate the signal passbands 1108 and the ASE passbands 1112 on the local MUX WSS 1100, the local MUX orchestrator 1028 may transmit passband loading commands 1048 to the local MUX control blocks 1016. The passband loading commands 1048 may include a passband loading list identifying certain passbands (i.e., certain ones of the signal passbands 1108 and the ASE passbands 1112) to be either activated or deactivated on the local MUX WSS 1100.

The local MUX control blocks 1016 may then attempt to activate or deactivate on the local MUX WSS 1100 each of the passbands identified by the local passband loading list. Then, after each of the passbands identified by the local passband loading list are either activated or deactivated on the local MUX WSS 1100—or after an attempt to either activate or deactivate each of the passbands identified by the local passband loading list on the local MUX WSS 1100 has completed, regardless of whether the attempt was successful—the local MUX control blocks 1016 may transmit local passband state messages 1052 to the local MUX orchestrator 1028. The local passband state messages 1052 may identify each of the passbands identified by the local passband loading list and may include an activation state (i.e., activated or deactivated) for each of the passbands identified by the local passband loading list. The local MUX orchestrator 1028 may then transmit the local passband state messages 1052 to the local MUX connection cache 1036, which may store the activation state of each of the passbands.

Similarly, in order to either activate or deactivate certain ones of the passbands (i.e., the signal passbands 1108 and the ASE passbands 1112) on the downstream DEMUX WSS 1200, the downstream DEMUX orchestrator 1040 may transmit downstream passband loading commands 1056 to the downstream DEMUX control blocks 1024. The downstream passband loading commands 1056 may include a downstream passband loading list identifying certain ones of the passbands to be either activated or deactivated on the downstream DEMUX WSS 1200.

The downstream DEMUX control blocks 1024 may then attempt to activate or deactivate on the downstream DEMUX WSS 1200 each of the passbands identified by the downstream passband loading list. Then, after each of the passbands identified by the downstream passband loading list are either activated or deactivated on the downstream DEMUX WSS 1200—or after an attempt to either activate or deactivate each of the passbands identified by the downstream passband loading list on the downstream DEMUX WSS 1200 has completed, regardless of whether the attempt was successful—the downstream DEMUX control blocks 1024 may transmit downstream passband state messages 1060 to the downstream DEMUX orchestrator 1040. The downstream passband state messages 1060 may identify each of the passbands identified by the downstream passband loading list and may include an activation state (i.e., activated or deactivated) for each of the passbands identified by the downstream passband loading list. The downstream DEMUX orchestrator 1040 may then transmit the downstream passband state messages 1060 to the downstream DEMUX connection cache 1044, which may store the activation state of each of the passbands.

In accordance with the present disclosure, the downstream DEMUX orchestrator 1040 may also transmit downstream band signal status messages 1064 to the local MUX orchestrator 1028. The downstream band signal status messages 1064 may indicate a downstream band signal status, which may indicate whether any of the passbands in one or more predetermined frequency ranges (e.g., a C-band or an L-band) are UP (i.e., activated) or DOWN (i.e., deactivated) on the downstream DEMUX WSS 1200 for transmission of client data (i.e., signal passbands 1108). In some embodiments, the downstream band signal status messages 1064 may include a downstream C-band signal status and a downstream L-band signal status. The downstream C-band signal status may indicate whether any of the passbands in the C-band frequency range are UP (i.e., activated) on the downstream DEMUX WSS 1200 for transmission of client data (i.e., signal passbands 1108). The downstream L-band signal status may indicate whether any of the passbands in the L-band frequency range are UP (i.e., activated) on the downstream DEMUX WSS 1200 for transmission of client data (i.e., signal passbands 1108).

The local MUX orchestrator 1028 may transmit passband loading requests 1068 (also referred to herein as “optical service loading requests”) to the local MUX loading manager 1032. The passband loading requests 1068 may identify a requested passband list of one or more requested passbands (hereinafter the “requested passbands” or each individually a “requested passband”) to be either activated or deactivated on the local MUX WSS 1100 for transmission of the optical content. The passband loading requests 1068 may also include one or more of the downstream band signal status, the downstream C-band signal status, and the downstream L-band signal status.

After receiving the passband loading request 1068, the local MUX loading manager 1032 may determine a subset of the requested passbands to be either activated or deactivated on the local MUX WSS 1100 across one or more loading cycles for transmission of the optical content. The local MUX loading manager 1032 may make the determination based at least in part on one or more of downstream band signal status, the downstream C-band signal status, and the downstream L-band signal status. The local MUX loading manager 1032 may then respond to the passband loading requests 1068 by transmitting passband loading responses 1072 to the local MUX orchestrator 1028. The passband loading responses 1072 may identify the subset of the requested passbands to be either activated or deactivated on the local MUX WSS 1100 across one or more loading cycles for transmission of the optical content.

The local MUX loading manager 1032 may also retrieve (or get) an activation state message 1076 indicating the activation state of each of the passbands from the local MUX connection cache 1036. The local MUX loading manager 1032 may utilize the activation state message 1076 in making loading management decisions and/or determining worst-case SRS estimations. In such cases, it may be beneficial for the local MUX loading manager 1032 to be aware of which portions of the spectrum are loaded and which optical content is being transmitted over the optical fiber link 1008.

In some embodiments, a number of the one or more loading cycles across which the subset of the requested passbands are to be either activated or deactivated on the local MUX WSS 1100 may also be determined based at least in part on: (i) whether one or more of the requested passbands are in a particular frequency range (e.g., a C-band frequency range or an L-band frequency range); and (ii) one or more of downstream band signal status, the downstream C-band signal status, and the downstream L-band signal status. That is, based at least in part on the particular frequency range of each of the requested passbands and one or more of downstream band signal status, the downstream C-band signal status, and the downstream L-band signal status, the local MUX loading manager 1032 may determine to perform one of: (i) a “conservative” loading; (ii) an “aggressive moderate” loading; (iii) an “aggressive moderate” loading for certain ones of the requested passbands in a particular frequency range (e.g., one of the C-band frequency range and the L-band frequency range) followed by a “conservative” loading for other ones of the requested passbands in another particular frequency range (e.g., the other of the C-band frequency range and the L-band frequency range); and (iv) an “aggressive high loading”.

Generally, a “conservative” loading requires more loading cycles than an “aggressive moderate” loading, which requires more loading cycles than an “aggressive high” loading. In some embodiments, a “conversative” loading may require a similar number of loading cycles as a loading without taking the downstream band signal status into consideration. In some embodiments, an “aggressive high” loading may require only a single loading cycle. However, in other embodiments, an “aggressive high” loading may require more than one loading cycle.

In some embodiments, the local MUX loading manager 1032 may make the determination of whether to perform a conservative loading, an aggressive moderate loading followed by a conservative loading, an aggressive moderate loading, or an aggressive high loading as illustrated below in Table 1.

TABLE 1
Loading Conditions and Determinations by Local MUX Loading Manager 1032

| | | Frequency Range of | |
|---|---|---|---|
| Downstream C-band | Downstream L-band | Passbands in Loading | Loading Response |
| Signal Status | Signal Status | Request | Pattern |
| DOWN | DOWN | Any | Aggressive High |
| UP | DOWN | C-band Only | Aggressive Moderate |
| UP | DOWN | L-band Only | Conservative |
| UP | DOWN | Mix of C-band and | Aggressive Moderate |
| | | L-band | for C-band, followed |
| | | | by Conservative for |
| | | | L-band |
| DOWN | UP | L-band Only | Aggressive Moderate |
| DOWN | UP | C-band Only | Conservative |
| DOWN | UP | Mix of C-band and | Aggressive Moderate |
| | | L-band | for L-band, followed |
| | | | by Conservative for |
| | | | C-band |

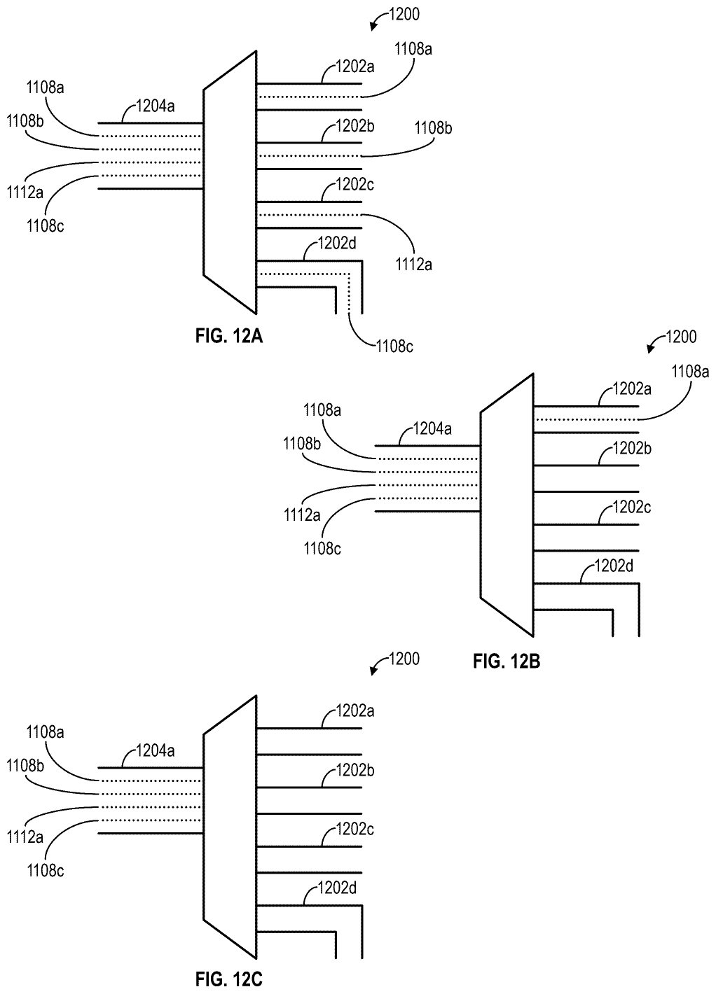

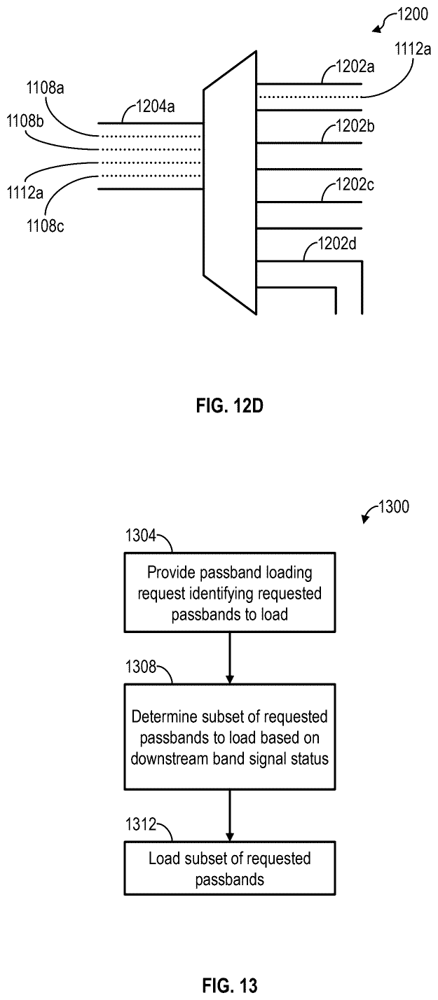

Referring now to FIGS. 12A-12D, shown therein is an exemplary embodiment of the downstream DEMUX WSS 1200 constructed in accordance with the present disclosure. As shown in FIGS. 12A-12D, the downstream DEMUX WSS 1200 may comprise one or more DEMUX line ports 1204a-n (hereinafter the “DEMUX line ports 1204” or each individually a “DEMUX line port 1204”) (e.g., a first DEMUX line port 1204b shown in FIGS. 12A-12D) and one or more DEMUX tributary ports 1202a-n (hereinafter the “DEMUX tributary ports 1202” or each individually a “DEMUX tributary port 1202”) (also referred to herein as a “DEMUX system ports”) (e.g., a first DEMUX tributary port 1202a, a second DEMUX tributary port 1202b, a third DEMUX tributary port 1202c, and a fourth DEMUX tributary port 1202d shown in FIGS. 12A-12D). The downstream DEMUX WSS 1200 may receive optical content via at least one of the DEMUX line ports 1204.

The downstream DEMUX WSS 1200 may be generally operable to selectively route optical content between the DEMUX line ports 1204 and the DEMUX tributary ports 1202 to selectively activate and deactivate the signal passbands 1108 and the ASE passbands 1112. In the embodiment shown in FIGS. 12A-12D, the downstream DEMUX WSS 1200 receives, via the first DEMUX line port 1204a, the first signal passband 1108a, the second signal passband 1108b, the third signal passband 1108c, and the first ASE passband 1112a. Further, in the embodiment shown in FIGS. 12A-12D, the downstream DEMUX WSS 1200 transmits the first signal passband 1108a via the first DEMUX tributary port 1202a, the second signal passband 1108b via the second DEMUX tributary port 1202b, the first ASE passband 1112a via the third DEMUX tributary port 1202c, and the third signal passband 1108c via the fourth DEMUX tributary port 1202d.

In the embodiment shown in FIGS. 12A-12D, the fourth DEMUX tributary port 1202d is depicted as a drop port configured to be coupled to a destination of the signal passbands 1108 (e.g., the light sink 100) to transmit the signal passbands 1108 for decoding and processing, for example. However, it should be understood that a number of the DEMUX tributary ports 1202 implemented as drop ports configured to be coupled to a destination of the signal passbands 1108 (e.g., the light sink 100) may be greater or fewer than one.

As depicted in FIG. 12A, the downstream DEMUX WSS 1200 transmits the first signal passband 1108a from the first DEMUX tributary port 1202a, the second signal passband 1108b from the second DEMUX tributary port 1202b, the first ASE passband 1112a from the third DEMUX tributary port 1202c, and the third signal passband 1108c from the fourth DEMUX tributary port 1202d. In such an embodiment, the downstream band signal status may be UP, thereby indicating that at least one of the passbands in one or more predetermined frequency ranges are activated for transmission of client data.

In an embodiment wherein at least one of the signal passbands 1108 is in the C-band frequency range and at least one of the signal passbands 1108 is in the L-band frequency range, for example, the downstream C-band signal status may be UP, thereby indicating that at least one of the passbands in the C-band frequency range are activated for transmission of client data, and the downstream L-band signal status may be UP, thereby indicating that at least one of the passbands in the L-band frequency range are activated for transmission of client data.

In an embodiment wherein each of the signal passbands 1108 are in the C-band frequency range, for example, the downstream C-band signal status may be UP, thereby indicating that at least one of the passbands in the C-band frequency range are activated for transmission of client data, and the downstream L-band signal status may be DOWN, thereby indicating that none of the passbands in the L-band frequency range are activated for transmission of client data.

In an embodiment wherein each of the signal passbands 1108 are in the L-band frequency range, for example, the downstream C-band signal status may be DOWN, thereby indicating that none of the passbands in the C-band frequency range are activated for transmission of client data, and the downstream L-band signal status may be UP, thereby indicating that at least one of the passbands in the L-band frequency range are activated for transmission of client data.

As depicted in FIG. 12B, the downstream DEMUX WSS 1200 transmits only the first signal passband 1108a from the first DEMUX tributary port 1202a. In such an embodiment, the downstream band signal status may be UP, thereby indicating that at least one of the passbands in one or more predetermined frequency ranges are activated for transmission of client data.

In an embodiment wherein the first signal passband 1108a is in the C-band frequency range, for example, the downstream C-band signal status may be UP, thereby indicating that at least one of the passbands in the C-band frequency range are activated for transmission of client data, and the downstream L-band signal status may be DOWN, thereby indicating that none of the passbands in the L-band frequency range are activated for transmission of client data.

In an embodiment wherein the first signal passband 1108a is in the L-band frequency range, for example, the downstream C-band signal status may be DOWN, thereby indicating that none of the passbands in the C-band frequency range are activated for transmission of client data, and the downstream L-band signal status may be UP, thereby indicating that at least one of the passbands in the L-band frequency range are activated for transmission of client data.

As depicted in FIG. 12C, the downstream DEMUX WSS 1200 does not transmit any of the signal passbands 1108 from the DEMUX tributary ports 1202. In such an embodiment, the downstream band signal status may be DOWN, thereby indicating that none of the passbands in one or more predetermined frequency ranges are activated for transmission of client data. Similarly, the downstream C-band signal status may be DOWN, thereby indicating that none of the passbands in the C-band frequency range are activated for transmission of client data, and the downstream L-band signal status may be DOWN, thereby indicating that none of the passbands in the L-band frequency range are activated for transmission of client data.

As depicted in FIG. 12D, the downstream DEMUX WSS 1200 transmits only the first ASE passband 1112a from the first DEMUX tributary port 1202a. In such an embodiment, the downstream band signal status may be DOWN, thereby indicating that none of the passbands in one or more predetermined frequency ranges are activated for transmission of client data, the downstream C-band signal status may be DOWN, thereby indicating that none of the passbands in the C-band frequency range are activated for transmission of client data, and the downstream L-band signal status may be DOWN, thereby indicating that none of the passbands in the L-band frequency range are activated for transmission of client data.

Referring now to FIG. 13, shown therein is a process flow diagram of an exemplary embodiment of a method 1300 of loading (i.e., activating and/or deactivating) passbands in accordance with the present disclosure. As shown in FIG. 13, the method 1300 generally comprises the steps of: providing, by the local MUX orchestrator 1028, a passband loading request 1068 identifying one or more requested passbands to be loaded (i.e., activated or deactivated) on the local MUX WSS 1100 for transmission of optical content (step 1304); determining, by the local MUX loading manager 1032, a subset of the one or more requested passbands to be loaded (i.e., activated or deactivated) on the local MUX WSS 1100 across one or more loading cycles for transmission of the optical content based at least in part on a downstream band signal status (step 1308); and loading (i.e., activating or deactivating), by at least one of the local MUX control blocks 1016, the subset of the one or more requested passbands on the local MUX WSS 1100 across the one or more loading cycles for transmission of the optical content (step 1312).

In some embodiments, the step of determining the subset of the one or more requested passbands to be loaded (i.e., activated or deactivated) on the local MUX WSS 1100 across the one or more loading cycles for transmission of the optical content based at least in part on the downstream band signal status (step 1308) is further defined as determining, by the local MUX loading manager 1032, the subset of the one or more requested passbands to be loaded (i.e., activated or deactivated) on the local MUX WSS 1100 across the one or more loading cycles for transmission of the optical content based at least in part on a downstream C-band signal status and/or a downstream L-band signal status, wherein the downstream C-band signal status indicates whether any of the plurality of passbands in the C-band frequency range are activated on the downstream DEMUX WSS 1200 for transmission of the client data, the downstream L-band signal status indicating whether any of the plurality of passbands in an L-band frequency range activated on the downstream DEMUX WSS 1200 for transmission of the client data.

In some embodiments in which the downstream band signal status includes the downstream C-band signal status and/or the downstream L-band signal status, the step of determining the subset of the one or more requested passbands to be loaded (i.e., activated or deactivated) on the local MUX WSS 1100 across the one or more loading cycles for transmission of the optical content based at least in part on the downstream band signal status (step 1308) is further defined as determining, by the local MUX loading manager 1032, the subset of the one or more requested passbands to be loaded (i.e., activated or deactivated) on the local MUX WSS 1100 across the one or more loading cycles for transmission of the optical content based at least in part on the downstream C-band signal status indicating that none of the plurality of passbands in the C-band frequency range are activated on the downstream DEMUX WSS 1200 for transmission of the client data and the downstream L-band signal status indicating that none of the plurality of passbands in the L-band frequency range are activated on the downstream DEMUX WSS 1200 for transmission of the client data. In such embodiments, the subset of the one or more requested passbands may include each of the one or more requested passbands, and loading (i.e., activating or deactivating) the subset of the one or more requested passbands on the local MUX WSS 1100 across the one or more loading cycles for transmission of the optical content (step 1312) is further defined as loading (i.e., activating or deactivating) the subset of the one or more requested passbands on the local MUX WSS 1100 during a first loading cycle for transmission of the optical content.

In some embodiments in which the downstream band signal status includes the downstream C-band signal status and/or the downstream L-band signal status, the step of determining the subset of the one or more requested passbands to be loaded (i.e., activated or deactivated) on the local MUX WSS 1100 across the one or more loading cycles for transmission of the optical content based at least in part on the downstream band signal status (step 1308) is further defined as determining, by the local MUX loading manager 1032, a first subset of the one or more requested passbands to be loaded (i.e., activated or deactivated) on the local MUX WSS 1100 across one or more first loading cycles for transmission of the optical content based at least in part on the downstream C-band signal status indicating that at least one of the plurality of passbands in the C-band frequency range are activated on the downstream DEMUX WSS 1200 for transmission of the client data and the downstream L-band signal status indicating that none of the plurality of passbands in the L-band frequency range are activated on the downstream DEMUX WSS 1200 for transmission of the client data. In such embodiments, the first subset of the one or more requested passbands may include each of the one or more requested passbands in the C-band frequency range and none of the one or more requested passbands in the L-band frequency range.

Subsequently in such embodiments, the method 1300 may further comprise determining, by the local MUX loading manager 1032, a second subset of the one or more requested passbands to be loaded (i.e., activated or deactivated) on the local MUX WSS 1100 across one or more second loading cycles for transmission of the optical content based at least in part on the downstream band signal status, wherein the second subset of the one or more requested passbands includes each of the one or more requested passbands in the L-band frequency range. In such embodiments, a first number of the one or more first loading cycles may be fewer than a second number of the one or more second loading cycles. Then, the method 1300 may further comprise loading (i.e., activating or deactivating), by at least one of the local MUX control blocks 1016, each of the second subset of the one or more requested passbands on the local MUX WSS 1100 across the one or more second loading cycles for transmission of the optical content.

In some embodiments in which the downstream band signal status includes the downstream C-band signal status and/or the downstream L-band signal status, the step of determining the subset of the one or more requested passbands to be loaded (i.e., activated or deactivated) on the local MUX WSS 1100 across the one or more loading cycles for transmission of the optical content based at least in part on the downstream band signal status (step 1308) is further defined as determining, by the local MUX loading manager 1032, a first subset of the one or more requested passbands to be loaded (i.e., activated or deactivated) on the local MUX WSS 1100 across one or more first loading cycles for transmission of the optical content based at least in part on the downstream C-band signal status indicating that none of the plurality of passbands in the C-band frequency range are activated on the downstream DEMUX WSS 1200 for transmission of the client data and the downstream L-band signal status indicating that at least one of the plurality of passbands in the L-band frequency range are activated on the downstream DEMUX WSS 1200 for transmission of the client data. In such embodiments, the subset of the one or more requested passbands may include each of the one or more requested passbands in the L-band frequency range and none of the one or more requested passbands in the C-band frequency range.

Subsequently in such embodiments, the method 1300 may further comprise determining, by the local MUX loading manager 1032, a second subset of the one or more requested passbands to be loaded (i.e., activated or deactivated) on the local MUX WSS 1100 across one or more second loading cycles for transmission of the optical content based at least in part on the downstream band signal status. In such embodiments, the second subset of the one or more requested passbands may include each of the one or more requested passbands in the C-band frequency range. In such embodiments, a first number of the one or more first loading cycles may be fewer than a second number of the one or more second loading cycles. Then, the method 1300 may further comprise loading (i.e., activating or deactivating) by at least one of the local MUX control blocks 1016, each of the second subset of the one or more requested passbands on the local MUX WSS 1100 across the one or more second loading cycles for transmission of the optical content.

In some embodiments, the method 1300 may further comprise receiving, by the local MUX orchestrator 1028, the downstream band signal status from the downstream DEMUX orchestrator 1040. In some such embodiments, the local MUX orchestrator 1028 may receive the downstream band signal status from the downstream DEMUX orchestrator 1040 via one of an in-band communication channel and an out of-band communication channel. In at least one embodiment, the local MUX orchestrator 1028 may receive the downstream band signal status from the downstream DEMUX orchestrator 1040 via an Optical Supervisory Channel (OSC) (i.e., an in-band communication channel of the optical fiber link 1008). In at least one other embodiment, the local MUX orchestrator 1028 may receive the downstream band signal status from the downstream DEMUX orchestrator 1040 via a Data Communication Network (DCN) (i.e., an out-of-band communication channel of a transmission medium separate from the optical fiber link 1008, such as an Ethernet link for example).

In some embodiments, the method 1300 may further comprise: determining, by the downstream DEMUX orchestrator 1040, the downstream C-band signal status based at least in part on whether any of the plurality of passbands in the C-band frequency range are activated on the downstream DEMUX WSS 1200 for transmission of the client data; and determining, by the downstream DEMUX orchestrator 1040, the downstream L-band signal status based at least in part on whether any of the plurality of passbands in the L-band frequency range are activated on the downstream DEMUX WSS 1200 for transmission of the client data.

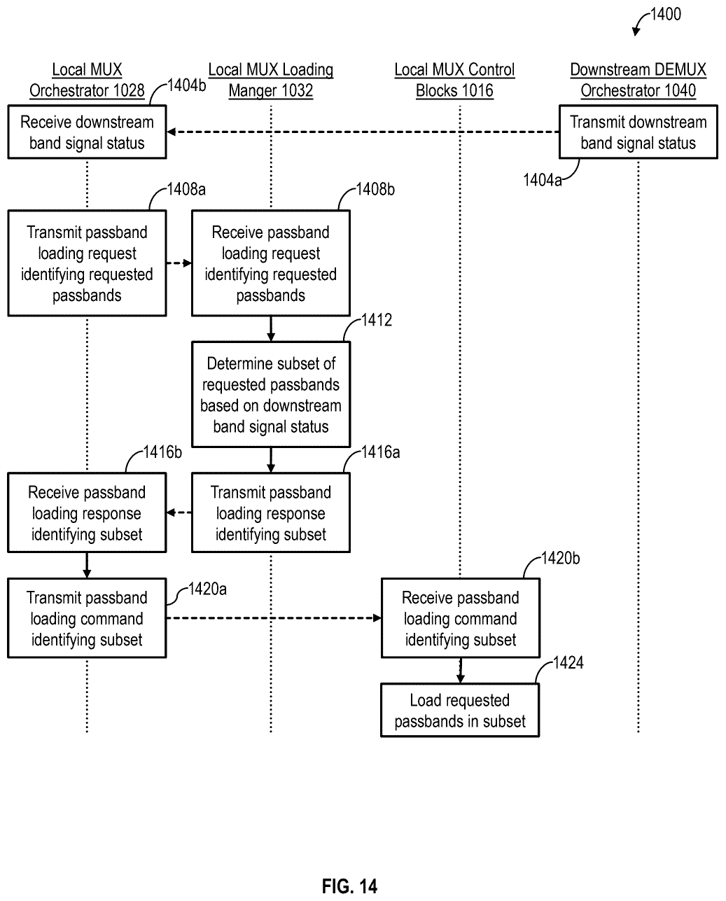

Referring now to FIG. 14, shown therein is a cross-functional process flow diagram of another exemplary embodiment of a method 1400 of loading (i.e., activating and/or deactivating) passbands in accordance with the present disclosure. As shown in FIG. 14, the method 1400 generally comprises the steps of: transmitting, by the downstream DEMUX orchestrator 1040, a downstream band signal status message 1064 to the local MUX orchestrator 1028, the downstream band signal status message 1064 indicating whether any of the passbands in the predetermined frequency ranges are activated on the downstream DEMUX WSS 1200 for transmission of the client data (step 1404a); receiving, by the local MUX orchestrator 1028, the downstream band signal status message 1064 (step 1404b); transmitting, by the local MUX orchestrator 1028, the passband loading request 1068 to the local MUX loading manager 1032, the passband loading request 1068 identifying the requested passbands to be loaded (i.e., activated or deactivated) on the local MUX WSS 1100 for transmission of the optical content (step 1408a); receiving, by the local MUX loading manager 1032, the passband loading request 1068 (step 1408b); determining, by the local MUX loading manager 1032, a subset of the requested passbands to be loaded (i.e., activated or deactivated) on the local MUX WSS 1100 across one or more loading cycles for transmission of the optical content based at least in part on the downstream band signal status message 1064 (step 1412); transmitting, by the local MUX loading manager 1032, the passband loading response 1072 to the local MUX orchestrator 1028, the passband loading response 1072 identifying the subset of the requested passbands (step 1416a); receiving, by the local MUX orchestrator 1028, the passband loading response 1072 (step 1416b); transmitting, by the local MUX orchestrator 1028, the passband loading command 1048 to the local MUX control blocks 1016, the passband loading command 1048 identifying the subset of the requested passbands (step 1420a); receiving, by the local MUX control blocks 1016, the passband loading command 1048 (step 1420b); and loading (i.e., activating or deactivating), by the local MUX control blocks 1016, the subset of the requested passbands on the local MUX WSS 1100 across one or more loading cycles for transmission of the optical content (step 1424).

### Non-Limiting Illustrative Clauses

Exemplary, non-limiting illustrative clauses are provided in the clauses below. However, the scope of the present inventive concept(s) is to be understood to not be limited in any manner by the clauses presented below.

Illustrative clause 1. A network element, comprising: a processor; an amplified spontaneous emission (ASE) source operable to generate ASE noise; a line port configured to be optically coupled to an optical fiber link; one or more tributary ports, at least one of the one or more tributary ports configured to be optically coupled to the ASE source; a wavelength selective switch (WSS) in optical communication with the line port and the one or more tributary ports, the WSS being configured to selectively route optical content between the one or more tributary ports and the line port to selectively activate and deactivate a plurality of passbands for transmission of the optical content via the line port over the optical fiber link, the optical content having been received via at least one of the one or more tributary ports and including one or more of client data and the ASE noise; a memory comprising a non-transitory processor-readable medium storing an orchestrator application, a loading manager application, one or more control block applications, and processor-executable instructions that when executed by the processor cause the processor to: provide, by the orchestrator application, an optical service loading request identifying one or more requested passbands of the plurality of passbands to be one of activated and deactivated on the WSS for transmission of the optical content; determine, by the loading manager application, a subset of the one or more requested passbands to be one of activated and deactivated on the WSS across one or more loading cycles for transmission of the optical content based at least in part on a downstream band signal status indicating whether any of the plurality of passbands in one or more predetermined frequency ranges are activated on a downstream WSS of a downstream network element for transmission of the client data; and activate or deactivate, by at least one of the one or more control block applications, the subset of the one or more requested passbands on the WSS across the one or more loading cycles for transmission of the optical content.

Illustrative clause 2. The network element of illustrative clause 1, wherein the downstream band signal status includes a downstream C-band signal status and a downstream L-band signal status, the downstream C-band signal status indicating whether any of the plurality of passbands in a C-band frequency range are activated on the downstream WSS for transmission of the client data, the downstream L-band signal status indicating whether any of the plurality of passbands in an L-band frequency range are activated on the downstream WSS for transmission of the client data.

Illustrative clause 3. The network element of illustrative clause 2, wherein the downstream C-band signal status indicates that none of the plurality of passbands in the C-band frequency range are activated on the downstream WSS for transmission of the client data, the downstream L-band signal status indicating that none of the plurality of passbands in the L-band frequency range are activated on the downstream WSS for transmission of the client data, the subset of the one or more requested passbands including each of the one or more requested passbands, and wherein activating or deactivating the subset of the one or more requested passbands on the WSS across the one or more loading cycles for transmission of the optical content is further defined as activating or deactivating the subset of the one or more requested passbands on the WSS during a first loading cycle for transmission of the optical content.

Illustrative clause 4. The network element of illustrative clause 2, wherein the downstream C-band signal status indicates that at least one of the plurality of passbands in the C-band frequency range are activated on the downstream WSS for transmission of the client data, the downstream L-band signal status indicates that none of the plurality of passbands in the L-band frequency range are activated on the downstream WSS for transmission of the client data, and the subset of the one or more requested passbands includes each of the one or more requested passbands in the C-band frequency range and none of the one or more requested passbands in the L-band frequency range.

Illustrative clause 5. The network element of illustrative clause 4, wherein the one or more loading cycles are one or more first loading cycles, the processor-executable instructions when executed by the processor further causing the processor to: determine, by the loading manager application, a second subset of the one or more requested passbands to be one of activated and deactivated on the WSS across one or more second loading cycles for transmission of the optical content based at least in part on the downstream band signal status, the second subset of the one or more requested passbands including each of the one or more requested passbands in the L-band frequency range, the one or more second loading cycles being subsequent to the one or more first loading cycles, a first number of the one or more first loading cycles being fewer than a second number of the one or more second loading cycles; and activate or deactivate, by at least one of the one or more control block applications, each of the second subset of the one or more requested passbands on the WSS across the one or more second loading cycles for transmission of the optical content.

Illustrative clause 6. The network element of illustrative clause 2, wherein the downstream C-band signal status indicates that none of the plurality of passbands in the C-band frequency range are activated on the downstream WSS for transmission of the client data, the downstream L-band signal status indicates that at least one of the plurality of passbands in the L-band frequency range are activated on the downstream WSS for transmission of the client data, and the subset of the one or more requested passbands includes each of the one or more requested passbands in the L-band frequency range and none of the one or more requested passbands in the C-band frequency range.

Illustrative clause 7. The network element of illustrative clause 6, wherein the one or more loading cycles are one or more first loading cycles, the processor-executable instructions when executed by the processor further causing the processor to: determine, by the loading manager application, a second subset of the one or more requested passbands to be one of activated and deactivated on the WSS across one or more second loading cycles for transmission of the optical content based at least in part on the downstream band signal status, the second subset of the one or more requested passbands including each of the one or more requested passbands in the C-band frequency range, the one or more second loading cycles being subsequent to the one or more first loading cycles, a first number of the one or more first loading cycles being fewer than a second number of the one or more second loading cycles; and activate or deactivate, by at least one of the one or more control block applications, each of the second subset of the one or more requested passbands on the WSS across the one or more second loading cycles for transmission of the optical content.

Illustrative clause 8. The network element of illustrative clause 1, wherein the WSS is a multiplexer (MUX) WSS, the orchestrator application is a MUX orchestrator application, the loading manager application is a MUX loading manager application, the downstream WSS is a downstream demultiplexer (DEMUX) WSS, and the processor-executable instructions when executed by the processor further cause the processor to receive, by the MUX orchestrator application, the downstream band signal status from a downstream DEMUX orchestrator application of the downstream network element.

Illustrative clause 9. The network element of illustrative clause 8, wherein receiving, by the MUX orchestrator application, the downstream band signal status from the downstream DEMUX orchestrator application of the downstream network element is further defined as receiving, by the MUX orchestrator application, the downstream band signal status from the downstream DEMUX orchestrator application of the downstream network element via one of an in-band communication channel and an out of-band communication channel.

Illustrative clause 10. The network element of illustrative clause 8, wherein the downstream band signal status includes a downstream C-band signal status and a downstream L-band signal status, the downstream C-band signal status having been determined by the downstream DEMUX orchestrator application based at least in part on whether any of the plurality of passbands in a C-band frequency range are activated on the downstream DEMUX WSS for transmission of the client data, the downstream L-band signal status having been determined by the downstream DEMUX orchestrator application based at least in part on whether any of the plurality of passbands in an L-band frequency range are activated on the downstream DEMUX WSS for transmission of the client data.

Illustrative clause 11. A method, comprising: providing, by an orchestrator application of a network element, an optical service loading request, the network element comprising an amplified spontaneous emission (ASE) source operable to generate ASE noise, a line port optically coupled to an optical fiber link, one or more tributary ports wherein at least one of the one or more tributary ports is optically coupled to the ASE source, and a wavelength selective switch (WSS) in optical communication with the line port and the one or more tributary ports, the WSS being configured to selectively route optical content between the one or more tributary ports and the line port to selectively activate and deactivate a plurality of passbands for transmission of the optical content via the line port over the optical fiber link, the optical content having been received via at least one of the one or more tributary ports and including one or more of client data and the ASE noise, the optical service loading request identifying one or more requested passbands of the plurality of passbands to be one of activated and deactivated on the WSS for transmission of the optical content; determining, by a loading manager application of the network element, a subset of the one or more requested passbands to be one of activated and deactivated on the WSS across one or more loading cycles for transmission of the optical content based at least in part on a downstream band signal status indicating whether any of the plurality of passbands in one or more predetermined frequency ranges are activated on a downstream WSS of a downstream network element for transmission of the client data; and activating or deactivating, by at least one of one or more control block applications of the network element, the subset of the one or more requested passbands on the WSS across the one or more loading cycles for transmission of the optical content.

Illustrative clause 12. The method of illustrative clause 11, wherein determining the subset of the one or more requested passbands to be one of activated and deactivated on the WSS across the one or more loading cycles for transmission of the optical content based at least in part on the downstream band signal status is further defined as determining, by the loading manager application of the network element, the subset of the one or more requested passbands to be one of activated and deactivated on the WSS across the one or more loading cycles for transmission of the optical content based at least in part on the downstream band signal status, the downstream band signal status including a downstream C-band signal status and a downstream L-band signal status, the downstream C-band signal status indicating whether any of the plurality of passbands in a C-band frequency range are activated on the downstream WSS for transmission of the client data, the downstream L-band signal status indicating whether any of the plurality of passbands in an L-band frequency range activated on the downstream WSS for transmission of the client data.

Illustrative clause 13. The method of illustrative clause 12, wherein determining the subset of the one or more requested passbands to be one of activated and deactivated on the WSS across the one or more loading cycles for transmission of the optical content based at least in part on the downstream band signal status is further defined as determining, by the loading manager application of the network element, the subset of the one or more requested passbands to be one of activated and deactivated on the WSS across the one or more loading cycles for transmission of the optical content based at least in part on the downstream band signal status, the downstream band signal status including the downstream C-band signal status and the downstream L-band signal status, the downstream C-band signal status indicating that none of the plurality of passbands in the C-band frequency range are activated on the downstream WSS for transmission of the client data, the downstream L-band signal status indicating that none of the plurality of passbands in the L-band frequency range are activated on the downstream WSS for transmission of the client data, the subset of the one or more requested passbands including each of the one or more requested passbands, and wherein activating or deactivating the subset of the one or more requested passbands on the WSS across the one or more loading cycles for transmission of the optical content is further defined as activating or deactivating the subset of the one or more requested passbands on the WSS during a first loading cycle for transmission of the optical content.

Illustrative clause 14. The method of illustrative clause 12, wherein determining the subset of the one or more requested passbands to be one of activated and deactivated on the WSS across the one or more loading cycles for transmission of the optical content based at least in part on the downstream band signal status is further defined as determining, by the loading manager application of the network element, the subset of the one or more requested passbands to be one of activated and deactivated on the WSS across the one or more loading cycles for transmission of the optical content based at least in part on the downstream band signal status, the downstream band signal status including the downstream C-band signal status and the downstream L-band signal status, the downstream C-band signal status indicating that at least one of the plurality of passbands in the C-band frequency range are activated on the downstream WSS for transmission of the client data, the downstream L-band signal status indicating that none of the plurality of passbands in the L-band frequency range are activated on the downstream WSS for transmission of the client data, and the subset of the one or more requested passbands including each of the one or more requested passbands in the C-band frequency range and none of the one or more requested passbands in the L-band frequency range.

Illustrative clause 15. The method of illustrative clause 14, wherein the one or more loading cycles are one or more first loading cycles, the method further comprising: determining, by the loading manager application, a second subset of the one or more requested passbands to be one of activated and deactivated on the WSS across one or more second loading cycles for transmission of the optical content based at least in part on the downstream band signal status, the second subset of the one or more requested passbands including each of the one or more requested passbands in the L-band frequency range, the one or more second loading cycles being subsequent to the one or more first loading cycles, a first number of the one or more first loading cycles being fewer than a second number of the one or more second loading cycles; and activating or deactivating, by at least one of the one or more control block applications, each of the second subset of the one or more requested passbands on the WSS across the one or more second loading cycles for transmission of the optical content.

Illustrative clause 16. The method of illustrative clause 12, wherein determining the subset of the one or more requested passbands to be one of activated and deactivated on the WSS across the one or more loading cycles for transmission of the optical content based at least in part on the downstream band signal status is further defined as determining, by the loading manager application of the network element, the subset of the one or more requested passbands to be one of activated and deactivated on the WSS across the one or more loading cycles for transmission of the optical content based at least in part on the downstream band signal status, the downstream band signal status including the downstream C-band signal status and the downstream L-band signal status, the downstream C-band signal status indicating that none of the plurality of passbands in the C-band frequency range are activated on the downstream WSS for transmission of the client data, the downstream L-band signal status indicating that at least one of the plurality of passbands in the L-band frequency range are activated on the downstream WSS for transmission of the client data, and the subset of the one or more requested passbands including each of the one or more requested passbands in the L-band frequency range and none of the one or more requested passbands in the C-band frequency range.

Illustrative clause 17. The method of illustrative clause 16, wherein the one or more loading cycles are one or more first loading cycles, the method further comprising: determining, by the loading manager application, a second subset of the one or more requested passbands to be one of activated and deactivated on the WSS across one or more second loading cycles for transmission of the optical content based at least in part on the downstream band signal status, the second subset of the one or more requested passbands including each of the one or more requested passbands in the C-band frequency range, the one or more second loading cycles being subsequent to the one or more first loading cycles, a first number of the one or more first loading cycles being fewer than a second number of the one or more second loading cycles; and activating or deactivating, by at least one of the one or more control block applications, each of the second subset of the one or more requested passbands on the WSS across the one or more second loading cycles for transmission of the optical content.

Illustrative clause 18. The method of illustrative clause 11, wherein the WSS is a multiplexer (MUX) WSS, the orchestrator application is a MUX orchestrator application, the loading manager application is a MUX loading manager application, the downstream WSS is a downstream demultiplexer (DEMUX) WSS, and the method further comprising receiving, by the MUX orchestrator application, the downstream band signal status from a downstream DEMUX orchestrator application of the downstream network element.

Illustrative clause 19. The method of illustrative clause 18, wherein receiving, by the MUX orchestrator application, the downstream band signal status from the downstream DEMUX orchestrator application of the downstream network element is further defined as receiving, by the MUX orchestrator application, the downstream band signal status from the downstream DEMUX orchestrator application of the downstream network element via one of an in-band communication channel and an out of-band communication channel.

Illustrative clause 20. The method of illustrative clause 18, wherein the downstream band signal status includes a downstream C-band signal status and a downstream L-band signal status, the method further comprising: determining, by the downstream DEMUX orchestrator application, the downstream C-band signal status based at least in part on whether any of the plurality of passbands in a C-band frequency range are activated on the downstream DEMUX WSS for transmission of the client data; and determining, by the downstream DEMUX orchestrator application, the downstream L-band signal status based at least in part on whether any of the plurality of passbands in an L-band frequency range are activated on the downstream DEMUX WSS for transmission of the client data.

### CONCLUSION

The foregoing description provides illustration and description, but is not intended to be exhaustive or to limit the inventive concepts to the precise form disclosed. Modifications and variations are possible in light of the above teachings or may be acquired from practice of the methodologies set forth in the present disclosure.

Even though particular combinations of features are recited in the claims and/or disclosed in the specification, these combinations are not intended to limit the disclosure. In fact, many of these features may be combined in ways not specifically recited in the claims and/or disclosed in the specification. Although each dependent claim listed below may directly depend on only one other claim, the disclosure includes each dependent claim in combination with every other claim in the claim set.

No element, act, or instruction used in the present application should be construed as critical or essential to the invention unless explicitly described as such outside of the preferred embodiment. Further, the phrase “based on” is intended to mean “based, at least in part, on” unless explicitly stated otherwise.

What is claimed is:

1. A network element, comprising:
a processor;
an amplified spontaneous emission (ASE) source operable to generate ASE noise;
a line port configured to be optically coupled to an optical fiber link;
one or more tributary ports, at least one of the one or more tributary ports configured to be optically coupled to the ASE source;
a wavelength selective switch (WSS) in optical communication with the line port and the one or more tributary ports, the WSS being configured to selectively route optical content between the one or more tributary ports and the line port to selectively activate and deactivate a plurality of passbands for transmission of the optical content via the line port over the optical fiber link, the optical content having been received via at least one of the one or more tributary ports and including one or more of client data and the ASE noise;
a memory comprising a non-transitory processor-readable medium storing an orchestrator application, a loading manager application, one or more control block applications, and processor-executable instructions that when executed by the processor cause the processor to:
provide, by the orchestrator application, an optical service loading request identifying one or more requested passbands of the plurality of passbands to be one of activated and deactivated on the WSS for transmission of the optical content;
determine, by the loading manager application, a subset of the one or more requested passbands to be one of activated and deactivated on the WSS across one or more loading cycles for transmission of the optical content based at least in part on a downstream band signal status indicating whether any of the plurality of passbands in one or more predetermined frequency ranges are activated on a downstream WSS of a downstream network element for transmission of the client data; and
activate or deactivate, by at least one of the one or more control block applications, the subset of the one or more requested passbands on the WSS across the one or more loading cycles for transmission of the optical content.

2. The network element of claim 1, wherein the downstream band signal status includes a downstream C-band signal status and a downstream L-band signal status, the downstream C-band signal status indicating whether any of the plurality of passbands in a C-band frequency range are activated on the downstream WSS for transmission of the client data, the downstream L-band signal status indicating whether any of the plurality of passbands in an L-band frequency range are activated on the downstream WSS for transmission of the client data.

3. The network element of claim 2, wherein the downstream C-band signal status indicates that none of the plurality of passbands in the C-band frequency range are activated on the downstream WSS for transmission of the client data, the downstream L-band signal status indicating that none of the plurality of passbands in the L-band frequency range are activated on the downstream WSS for transmission of the client data, the subset of the one or more requested passbands including each of the one or more requested passbands, and wherein activating or deactivating the subset of the one or more requested passbands on the WSS across the one or more loading cycles for transmission of the optical content is further defined as activating or deactivating the subset of the one or more requested passbands on the WSS during a first loading cycle for transmission of the optical content.

4. The network element of claim 2, wherein the downstream C-band signal status indicates that at least one of the plurality of passbands in the C-band frequency range are activated on the downstream WSS for transmission of the client data, the downstream L-band signal status indicates that none of the plurality of passbands in the L-band frequency range are activated on the downstream WSS for transmission of the client data, and the subset of the one or more requested passbands includes each of the one or more requested passbands in the C-band frequency range and none of the one or more requested passbands in the L-band frequency range.

5. The network element of claim 4, wherein the one or more loading cycles are one or more first loading cycles, the processor-executable instructions when executed by the processor further causing the processor to:
determine, by the loading manager application, a second subset of the one or more requested passbands to be one of activated and deactivated on the WSS across one or more second loading cycles for transmission of the optical content based at least in part on the downstream band signal status, the second subset of the one or more requested passbands including each of the one or more requested passbands in the L-band frequency range, the one or more second loading cycles being subsequent to the one or more first loading cycles, a first number of the one or more first loading cycles being fewer than a second number of the one or more second loading cycles; and
activate or deactivate, by at least one of the one or more control block applications, each of the second subset of the one or more requested passbands on the WSS across the one or more second loading cycles for transmission of the optical content.

6. The network element of claim 2, wherein the downstream C-band signal status indicates that none of the plurality of passbands in the C-band frequency range are activated on the downstream WSS for transmission of the client data, the downstream L-band signal status indicates that at least one of the plurality of passbands in the L-band frequency range are activated on the downstream WSS for transmission of the client data, and the subset of the one or more requested passbands includes each of the one or more requested passbands in the L-band frequency range and none of the one or more requested passbands in the C-band frequency range.

7. The network element of claim 6, wherein the one or more loading cycles are one or more first loading cycles, the processor-executable instructions when executed by the processor further causing the processor to:
determine, by the loading manager application, a second subset of the one or more requested passbands to be one of activated and deactivated on the WSS across one or more second loading cycles for transmission of the optical content based at least in part on the downstream band signal status, the second subset of the one or more requested passbands including each of the one or more requested passbands in the C-band frequency range, the one or more second loading cycles being subsequent to the one or more first loading cycles, a first number of the one or more first loading cycles being fewer than a second number of the one or more second loading cycles; and
activate or deactivate, by at least one of the one or more control block applications, each of the second subset of the one or more requested passbands on the WSS across the one or more second loading cycles for transmission of the optical content.

8. The network element of claim 1, wherein the WSS is a multiplexer (MUX) WSS, the orchestrator application is a MUX orchestrator application, the loading manager application is a MUX loading manager application, the downstream WSS is a downstream demultiplexer (DEMUX) WSS, and the processor-executable instructions when executed by the processor further cause the processor to receive, by the MUX orchestrator application, the downstream band signal status from a downstream DEMUX orchestrator application of the downstream network element.

9. The network element of claim 8, wherein receiving, by the MUX orchestrator application, the downstream band signal status from the downstream DEMUX orchestrator application of the downstream network element is further defined as receiving, by the MUX orchestrator application, the downstream band signal status from the downstream DEMUX orchestrator application of the downstream network element via one of an in-band communication channel and an out of-band communication channel.

10. The network element of claim 8, wherein the downstream band signal status includes a downstream C-band signal status and a downstream L-band signal status, the downstream C-band signal status having been determined by the downstream DEMUX orchestrator application based at least in part on whether any of the plurality of passbands in a C-band frequency range are activated on the downstream DEMUX WSS for transmission of the client data, the downstream L-band signal status having been determined by the downstream DEMUX orchestrator application based at least in part on whether any of the plurality of passbands in an L-band frequency range are activated on the downstream DEMUX WSS for transmission of the client data.

11. A method, comprising:
providing, by an orchestrator application of a network element, an optical service loading request, the network element comprising an amplified spontaneous emission (ASE) source operable to generate ASE noise, a line port optically coupled to an optical fiber link, one or more tributary ports wherein at least one of the one or more tributary ports is optically coupled to the ASE source, and a wavelength selective switch (WSS) in optical communication with the line port and the one or more tributary ports, the WSS being configured to selectively route optical content between the one or more tributary ports and the line port to selectively activate and deactivate a plurality of passbands for transmission of the optical content via the line port over the optical fiber link, the optical content having been received via at least one of the one or more tributary ports and including one or more of client data and the ASE noise, the optical service loading request identifying one or more requested passbands of the plurality of passbands to be one of activated and deactivated on the WSS for transmission of the optical content;
determining, by a loading manager application of the network element, a subset of the one or more requested passbands to be one of activated and deactivated on the WSS across one or more loading cycles for transmission of the optical content based at least in part on a downstream band signal status indicating whether any of the plurality of passbands in one or more predetermined frequency ranges are activated on a downstream WSS of a downstream network element for transmission of the client data; and
activating or deactivating, by at least one of one or more control block applications of the network element, the subset of the one or more requested passbands on the WSS across the one or more loading cycles for transmission of the optical content.

12. The method of claim 11, wherein determining the subset of the one or more requested passbands to be one of activated and deactivated on the WSS across the one or more loading cycles for transmission of the optical content based at least in part on the downstream band signal status is further defined as determining, by the loading manager application of the network element, the subset of the one or more requested passbands to be one of activated and deactivated on the WSS across the one or more loading cycles for transmission of the optical content based at least in part on the downstream band signal status, the downstream band signal status including a downstream C-band signal status and a downstream L-band signal status, the downstream C-band signal status indicating whether any of the plurality of passbands in a C-band frequency range are activated on the downstream WSS for transmission of the client data, the downstream L-band signal status indicating whether any of the plurality of passbands in an L-band frequency range activated on the downstream WSS for transmission of the client data.

13. The method of claim 12, wherein determining the subset of the one or more requested passbands to be one of activated and deactivated on the WSS across the one or more loading cycles for transmission of the optical content based at least in part on the downstream band signal status is further defined as determining, by the loading manager application of the network element, the subset of the one or more requested passbands to be one of activated and deactivated on the WSS across the one or more loading cycles for transmission of the optical content based at least in part on the downstream band signal status, the downstream band signal status including the downstream C-band signal status and the downstream L-band signal status, the downstream C-band signal status indicating that none of the plurality of passbands in the C-band frequency range are activated on the downstream WSS for transmission of the client data, the downstream L-band signal status indicating that none of the plurality of passbands in the L-band frequency range are activated on the downstream WSS for transmission of the client data, the subset of the one or more requested passbands including each of the one or more requested passbands, and wherein activating or deactivating the subset of the one or more requested passbands on the WSS across the one or more loading cycles for transmission of the optical content is further defined as activating or deactivating the subset of the one or more requested passbands on the WSS during a first loading cycle for transmission of the optical content.

14. The method of claim 12, wherein determining the subset of the one or more requested passbands to be one of activated and deactivated on the WSS across the one or more loading cycles for transmission of the optical content based at least in part on the downstream band signal status is further defined as determining, by the loading manager application of the network element, the subset of the one or more requested passbands to be one of activated and deactivated on the WSS across the one or more loading cycles for transmission of the optical content based at least in part on the downstream band signal status, the downstream band signal status including the downstream C-band signal status and the downstream L-band signal status, the downstream C-band signal status indicating that at least one of the plurality of passbands in the C-band frequency range are activated on the downstream WSS for transmission of the client data, the downstream L-band signal status indicating that none of the plurality of passbands in the L-band frequency range are activated on the downstream WSS for transmission of the client data, and the subset of the one or more requested passbands including each of the one or more requested passbands in the C-band frequency range and none of the one or more requested passbands in the L-band frequency range.

15. The method of claim 14, wherein the one or more loading cycles are one or more first loading cycles, the method further comprising:
determining, by the loading manager application, a second subset of the one or more requested passbands to be one of activated and deactivated on the WSS across one or more second loading cycles for transmission of the optical content based at least in part on the downstream band signal status, the second subset of the one or more requested passbands including each of the one or more requested passbands in the L-band frequency range, the one or more second loading cycles being subsequent to the one or more first loading cycles, a first number of the one or more first loading cycles being fewer than a second number of the one or more second loading cycles; and
activating or deactivating, by at least one of the one or more control block applications, each of the second subset of the one or more requested passbands on the WSS across the one or more second loading cycles for transmission of the optical content.

16. The method of claim 12, wherein determining the subset of the one or more requested passbands to be one of activated and deactivated on the WSS across the one or more loading cycles for transmission of the optical content based at least in part on the downstream band signal status is further defined as determining, by the loading manager application of the network element, the subset of the one or more requested passbands to be one of activated and deactivated on the WSS across the one or more loading cycles for transmission of the optical content based at least in part on the downstream band signal status, the downstream band signal status including the downstream C-band signal status and the downstream L-band signal status, the downstream C-band signal status indicating that none of the plurality of passbands in the C-band frequency range are activated on the downstream WSS for transmission of the client data, the downstream L-band signal status indicating that at least one of the plurality of passbands in the L-band frequency range are activated on the downstream WSS for transmission of the client data, and the subset of the one or more requested passbands including each of the one or more requested passbands in the L-band frequency range and none of the one or more requested passbands in the C-band frequency range.

17. The method of claim 16, wherein the one or more loading cycles are one or more first loading cycles, the method further comprising:
determining, by the loading manager application, a second subset of the one or more requested passbands to be one of activated and deactivated on the WSS across one or more second loading cycles for transmission of the optical content based at least in part on the downstream band signal status, the second subset of the one or more requested passbands including each of the one or more requested passbands in the C-band frequency range, the one or more second loading cycles being subsequent to the one or more first loading cycles, a first number of the one or more first loading cycles being fewer than a second number of the one or more second loading cycles; and
activating or deactivating, by at least one of the one or more control block applications, each of the second subset of the one or more requested passbands on the WSS across the one or more second loading cycles for transmission of the optical content.

18. The method of claim 11, wherein the WSS is a multiplexer (MUX) WSS, the orchestrator application is a MUX orchestrator application, the loading manager application is a MUX loading manager application, the downstream WSS is a downstream demultiplexer (DEMUX) WSS, and the method further comprising receiving, by the MUX orchestrator application, the downstream band signal status from a downstream DEMUX orchestrator application of the downstream network element.

19. The method of claim 18, wherein receiving, by the MUX orchestrator application, the downstream band signal status from the downstream DEMUX orchestrator application of the downstream network element is further defined as receiving, by the MUX orchestrator application, the downstream band signal status from the downstream DEMUX orchestrator application of the downstream network element via one of an in-band communication channel and an out of-band communication channel.

20. The method of claim 18, wherein the downstream band signal status includes a downstream C-band signal status and a downstream L-band signal status, the method further comprising:
determining, by the downstream DEMUX orchestrator application, the downstream C-band signal status based at least in part on whether any of the plurality of passbands in a C-band frequency range are activated on the downstream DEMUX WSS for transmission of the client data; and
determining, by the downstream DEMUX orchestrator application, the downstream L-band signal status based at least in part on whether any of the plurality of passbands in an L-band frequency range are activated on the downstream DEMUX WSS for transmission of the client data.
